(19) United States
(12) Patent Application Publication
(10) Pub. No.: US 2026/0350741 A1
(43) Pub. Date: Nov. 5, 2026

(54) WIDE-ANGLE VISION SYSTEM FOR ROBOTIC DATA COLLECTION

(71) Applicants: Andrew James Barry, Somerville, MA (US); Peter Raymond Florence, San Francisco, CA (US); Andy Zeng, Stanford, CA (US); John Bryan Carter, Upton, MA (US); Erin Koksal, Cambridge, MA (US); Samantha N. Castellanos, Arlington, MA (US)

(72) Inventors: Andrew James Barry, Somerville, MA (US); Peter Raymond Florence, San Francisco, CA (US); Andy Zeng, Stanford, CA (US); John Bryan Carter, Upton, MA (US); Erin Koksal, Cambridge, MA (US); Samantha N. Castellanos, Arlington, MA (US)

(21) Appl. No.: 19/411,802

(22) Filed: Dec. 8, 2025

Related U.S. Application Data
(63) Continuation-in-part of application No. 19/198,481, filed on May 5, 2025.

(51) Int. Cl. G06T 3/4038; B25J 1/00; B25J 9/16; G06T 3/14; G06T 7/246; H04N 23/50

(52) U.S. Cl. CPC G06T 3/4038; B25J 1/00; B25J 9/1697; G06T 3/14; G06T 7/246; H04N 23/50; G06T 2207/10016; G06T 2207/20212

(57) ABSTRACT

A device comprising a hand-held manipulator and a camera assembly configured to capture a field of view encompassing a workspace centered on a forward-projecting axis and at least one visual feature angularly displaced by at least 90 degrees from the forward-projecting axis. The wide-angle field of view enables robust spatial tracking and mapping even when the workspace is occluded or the manipulator is operating in confined environments. A video processing system processes the video data to generate training information for robotic manipulation tasks, using bimanual Simultaneous Location and Mapping (SLAM) and other computer vision techniques.

### RELATED APPLICATIONS

This application is a continuation-in-part to U.S. patent application Ser. No. 19/198,481, filed May 5, 2025, which is incorporated by reference herein in its entirety.

### TECHNICAL FIELD

The present disclosures relate to robotics and machine learning technologies and, in some examples, to devices and systems to collect, process, and utilize wide-angle visual data for robotic manipulation training.

### BACKGROUND

Robotic manipulation systems use cameras, sensors, and mechanical grippers to enable robots to interact with objects in their environment. These systems may employ computational models or algorithms configured to combine computer vision for perceiving the environment, motion planning for determining movement trajectories, and control schemes for executing precise manipulations. Some systems use machine learning techniques to train these models using training data. Training data collection may involve recording demonstrations of manipulation tasks, which can then be used to train machine learning models to teach the model to control robots to replicate similar behaviors.

### BRIEF DESCRIPTION OF THE SEVERAL VIEWS OF THE DRAWINGS

Example embodiments are described in detail below with reference to the attached drawing figures.

FIG. 1 is a perspective view illustrating an example gripper device, according to some examples.

FIG. 2 is a right side view of a user's hand wearing the gripper device of FIG. 1 with field of view indicators, according to some examples.

FIG. 3 is a perspective view illustrating an alternative example gripper device with visually compliant regions and contrasting markers, according to some examples.

FIG. 4 is an exploded view illustrating components of the gripper device of FIG. 3, according to some examples.

FIG. 5 is a top view of a robot manipulator corresponding to the gripper device of FIG. 3, according to some examples.

FIG. 6A is a front view of a robot system with two arms equipped with the robot manipulators of FIG. 5, according to some examples.

FIG. 6B is a top view of different fingertip designs for a gripper device and robot manipulator with various grip textures and patterns, according to some examples.

FIG. 6C is a perspective view of fingertips of a gripper device or robot manipulator, according to some examples.

FIG. 6D is a perspective view of a visually compliant region of a fingertip of a gripper device or robot manipulator showing honeycomb structures deforming in response to force from engaging a surface, according to some examples.

FIG. 6E illustrates different grip surface textures and patterns, according to some examples.

FIG. 7 is a block diagram illustrating a system for training a computational model to operate a robot using data from gripper devices, according to some examples.

FIG. 8 is a flowchart illustrating operations of a method for training a computational model to operate a robot using data from gripper devices, according to some examples.

FIG. 9A is a right side view of a user's hand wearing the gripper device of FIG. 1 showing an example dual-camera joint field of view, according to some examples.

FIG. 9B is a right side view of a user's hand wearing the gripper device of FIG. 1 showing examples of visual features angularly displaced from the workspace but captured within the camera assembly field of view, according to some examples.

FIG. 10 is a flowchart illustrating operations of a method for automatically processing video data from camera assemblies of two hand-held devices to generate robotic training data, according to some examples.

FIG. 11 illustrates an example sorting and preprocessing stage of the system of FIG. 7, according to some examples.

FIG. 12 illustrates a machine-learning pipeline, according to some examples.

FIG. 13 illustrates training and use of a machine-learning program, according to some examples.

FIG. 14 is a diagrammatic representation of a machine in the form of a computer system within which a set of instructions may be executed to cause the machine to perform any one or more of the methodologies discussed herein, according to some examples.

FIG. 15 is a block diagram showing a software architecture within which examples may be implemented.

### DETAILED DESCRIPTION

The examples described herein relate to systems, devices, and methods for robotic data collection and training using wide-angle vision systems. These examples address challenges associated with collecting large-scale datasets for robotic behavior modeling, particularly in environments where traditional teleoperation and forward-facing camera systems encounter limitations.

Some examples provide systems and methods for collecting human demonstration data to train robots to perform manipulation tasks. A gripper device mounts to a user's hand and includes a first finger rotatable inward by the thumb and a second finger rotatable inward by other fingers. The device employs a transmissionless design in which the user directly actuates the fingers through rotary joints rather than linear rails or trigger mechanisms, enabling intuitive control and haptic feedback. A common rotational mechanism constrains the fingers to rotate jointly using gears, simplifying the grip width to a one-dimensional value.

A camera assembly mounted on the device captures both the manipulation workspace (including the device's fingers) and the environmental context. In some examples, a wide-angle or 360-degree camera provides an expanded field of view that includes features useful for spatial tracking, such as corners of walls, floors, and/or ceilings of an indoor environment. In some examples, the camera's center of mass is positioned above the user's hand to improve ergonomics. A mask can occlude the user's fingers from the camera view to better match the robot's perspective when employing a corresponding robot manipulator.

In some examples, the fingers incorporate specialized features including visually compliant regions with honeycomb structures that deform to provide visual indication of applied forces without requiring force sensors. High-contrast visual markers can be integrally molded into or otherwise integrally formed with the finger structure rather than added afterward, enabling precise tracking of finger positions. The fingers can also include multi-stiffness zones, multi-antipodal corresponding gripping surfaces, and textured gripping surfaces optimized for different manipulation tasks. Other mechanical gripping features and ergonomic features are described herein to improve the intuitiveness, effectiveness, and usability of the gripper devices to enable more effective collection of training data.

The system includes robot manipulators designed to match the visual and mechanical properties of the gripper devices. In some examples, the manipulators use low-backlash metal gears to precisely control finger positions. The robot manipulator fingers can be manufactured using the same injection molding process as the gripper devices to ensure consistent appearance and behavior. The hardware-agnostic design of the robot manipulators supports deployment across different robot platforms.

In some examples, the gripper device includes motion sensors, such as an inertial measurement unit (IMU) integrated into the camera assembly, to generate motion information (e.g., six-dimensional x-y-z-pitch-roll-yaw information) synchronized with the image data captured by the camera assembly. The motion information and image data can be processed to generate simultaneous localization and mapping (SLAM) data for use in training the model. Additional sensing capabilities are described herein to improve the value and usability of the collected training data.

The mechanical, visual, and sensor features of the gripper devices and corresponding robot manipulators of the system enable the efficient collection, processing, sorting, categorization, and application of high-quality training data to a machine learning pipeline for training computational models to control robots to perform various manipulation tasks. In some examples, the video and/or other sensor modality data is collected from a set of gripper devices while a user performs a manipulation task, then is automatically paired and synchronized to match left and right counterpart gripper data generated during the same manipulation task, is processed to generate secondary data streams (e.g., SLAM data, grip width data, visual deformation data indicative of forces acting on the fingers), and is provided as training data inputs to a model training process. Computational models are trained to control robots to replicate demonstrated manipulation behaviors while adapting to variations in the environment. The complete system integrates the gripper devices, robot manipulators, and computational pipeline to enable demonstration-based robot training across various robot platforms.

Some examples include a hand-held manipulator device configured to be operated by a user's hand to perform manipulation tasks. Data from various sensors or subsystems of the device is recorded during performance of the task, and this data can be collected and processed to generate training data for training a robotic control model to control a robot to perform the same or similar manipulation tasks. In some cases, a user can wear two hand-held manipulator devices, one on each hand, and the data from the two devices can be combined to generate the training data.

The hand-held manipulator device includes a camera assembly having at least one camera. The camera assembly is configured to capture a field of view that encompasses a workspace within which the manipulator can approach and interact with objects. The workspace can be considered to be defined by a three-dimensional space centered on a generally forward-projecting axis of the camera assembly or manipulator device. In addition, the field of view can be wide enough to include at least one visual feature of the environment that is angularly displaced by at least 90 degrees, or at least 135 degrees, from the forward-projecting axis. In some examples, the field of view encompasses more than a full 180-degree hemispheric view, or a full 360-degree spherical view. The camera assembly can include multiple cameras, in which case the wide-angle field of view can be a joint field of view of individual cameras, which can be stitched together or otherwise combined to form a unified wide-angle image. In other examples, the camera assembly can include a wide-angle camera by itself or in combination with one or more additional cameras.

The integration of a wide-angle field of view (FOV) camera assembly in a robotic data collection device can enables a range of advanced use cases that are not possible with traditional forward-facing camera systems. In Simultaneous Location and Mapping (SLAM) applications, the wide-angle FOV can allow the system to capture visual features from a broad expanse of the environment, including areas that are angularly displaced by a wide angle (e.g., more than 90 degrees or more than 135 degrees) from the manipulator's forward-projecting axis. This expanded coverage can improve the robustness and accuracy of SLAM by providing additional reference points for spatial mapping, even when the primary workspace is partially or fully occluded. In joint SLAM scenarios, where data is collected from multiple hand-held devices or manipulators (such as the two devices worn on the user's left and right hands), the wide-angle FOV facilitates the alignment and optimization of trajectories from different perspectives, enabling precise bimanual coordination and unified spatial mapping. The wide-angle FOV can be particularly advantageous when the manipulator device is operating in confined or occluded environments, such as when the device is inserted into a container or when a close-up object obstructs the forward-facing view of the camera assembly. In these situations, the ability to capture features located to the sides and/or rear of the device can ensure continuous environmental tracking and mapping, preventing loss of localization awareness and maintaining the integrity of the collected data. This capability can result in consistent, high-quality data for training robust machine learning models for robotic manipulation tasks in real-world, unstructured environments.

Some examples use commodity wide-angle cameras, such as an Insta360 X3, which provide omnidirectional spherical visual coverage using two wide-angle cameras, one front-facing and one rear-facing. Other examples can include camera arrays with multiple cameras, such as multiple non-wide-angle cameras, or a single camera with panoramic or omnidirectional 360-degree lenses. It will be appreciated that any camera assembly achieving a sufficiently wide-angle FOV for at least some portions of the FOV can potentially be used to implement various examples described herein.

In some examples, the camera assembly is mounted above and at a rear portion of the manipulator device, close to the user's wrist. In some examples, the camera assembly is positioned such that the center of mass of the assembly is close to or slightly behind the user's wrist, providing a counterweight to the fingers and other components of the manipulator device.

Some example devices include markers, such as April grid markers, QR codes, or printed numbers, that are visible to the camera assembly and encode metadata such as operator identifier codes, collection site identification, task information, and/or hardware version tracking information. The encoded information may enable automated tracking and organization of data collected from multiple devices, users, recorded sessions, and locations.

Some examples can be integrated into a system for training a robot using data collected from hand-wearable manipulator devices. The system may include a sorting and preprocessing stage that receives temporal data streams from multiple devices, including video data, motion data (e.g., from an inertial measurement unit (IMU) of each manipulator device), audio data from a microphone of each manipulator device, location data, time stamp data, device identifier data, user identifier data, task identifier data, and/or any other data recorded by or otherwise associated with the video data recorded by the camera assembly during a recoded session. The sorting and preprocessing stage can perform data processing tasks such as automatically pairing and synchronizing data from two devices used in a user's left and right hands to perform the same manipulation task during a single session.

The sorting and preprocessing stage can process the temporal data stream of each device, including the video data recorded by each camera assembly and the motion data recorded by each IMU, to perform SLAM. The spatial maps generated by SLAM can be used to pair the data from the two devices. SLAM may be performed for each hand independently, followed by joint SLAM optimization to align and combine the left-hand SLAM data and right-hand SLAM data, aligning the trajectories of both hands in the same map. The joint SLAM process can improve the accuracy of individual hand trajectories by leveraging the motion of one hand to constrain the modeled position of the other hand. In some examples, the system uses tightly-coupled vision-IMU fusion algorithms and probabilistic factor graphs, and can be configured to process stitched multi-camera video streams, such as equirectangular projections generated by a video stitching and projection subsystem. In some examples, the system performs other spatial mapping or tracking operations instead of, or in addition to, SLAM. For example, the system may employ fiducial-based localization using April tags in combination with visual odometry techniques that estimate relative motion from image sequences, such as methods based on the essential matrix and epipolar geometry, to derive hand trajectories instead of, or in addition to, performing full SLAM. In other cases, external tracking systems may be utilized to provide absolute or relative pose information, including infrared beacon arrays, time-of-flight or other depth-sensing tracking subsystems, and commercially available lighthouse-style tracking solutions (such as the Lighthouse VR system developed by Valve Corporation), which can be fused with or substituted for vision-based estimates to maintain robust spatial tracking when environmental conditions or occlusions make SLAM less effective.

In some examples, the system includes a subsystem to mask out dynamic objects visible in the FOV, such as humans, moving objects, and the manipulator device itself, from the video data. The masking subsystem can be implemented using a machine learning model trained to perform image segmentation on video frames to identify dynamic objects. The masking can help to prevent SLAM pipelines from breaking due to dynamic objects in the scene, potentially improving robustness in complex scenarios. In some examples, the video data can be compressed (e.g., using AV1 compression) with parameters tuned to minimize visual artifacts that could affect downstream model performance. In some examples, the video data is chunked into segments for efficient processing.

The output of the sorting and preprocessing stage can include synchronized pairs of video streams, unified spatial maps and bimanual trajectory data from the joint SLAM subsystem, manipulator state values (such as visually-observable states of the physical grippers or other manipulator components), and/or structured metadata files for use in model training. The preprocessing pipeline can include video cropping, downsampling, filtering, calibration, and/or manipulator state estimation using visual tracking features. The training data can be used to train a computational model to produce a trained model for robotic manipulation tasks.

Other features are described in the following disclosure and claims.

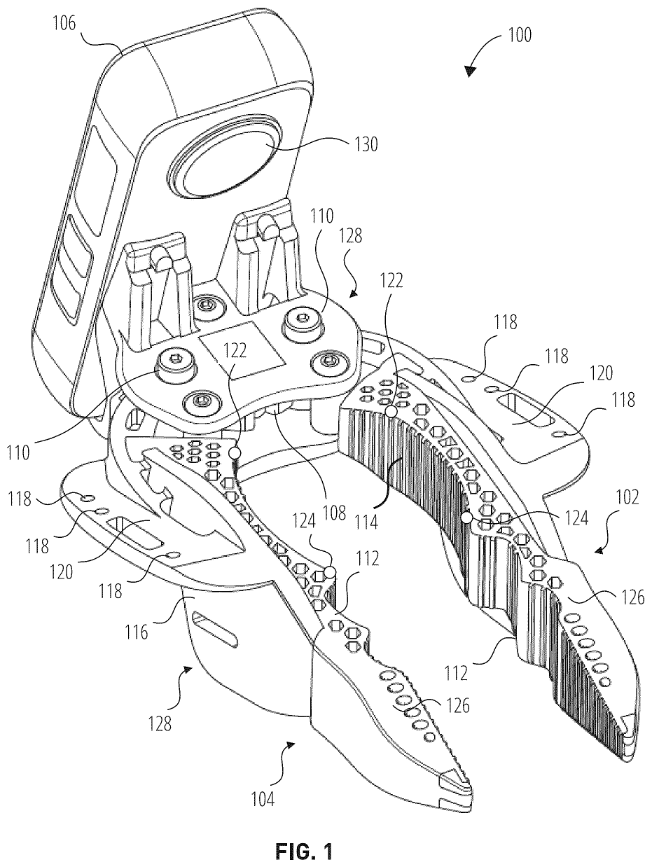

FIG. 1 illustrates a perspective view of an example hand-held manipulator device shown as gripper device 100.

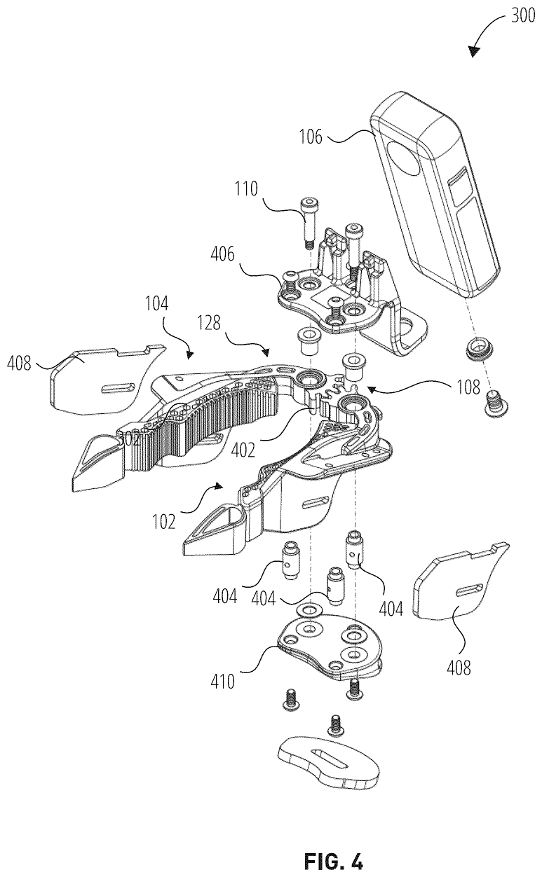

The gripper device 100 includes a camera assembly 106 mounted above and at a rear portion the device, close to the user's wrist. A left finger 102 and a right finger 104 extend forward from a common rotational mechanism 108 (shown in greater detail in FIG. 4). The fingers are rotatable inward toward each other through rotational joints 110.

The camera assembly 106 is mounted above and at a rear portion of the gripper device 100, positioned close to the user's wrist to provide wide-angle camera coverage of both the workspace and the surrounding environment. The illustrated example camera assembly 106 includes a front-facing camera 130, which is oriented to capture a field of view encompassing the workspace directly in front of the gripper device. This front-facing camera 130 is positioned and configured to record the manipulator's interaction with objects, including the movement and positioning of the gripper fingers, as well as the immediate area where manipulation tasks are performed. The placement and orientation of the front-facing camera 130 ensure that critical details of the manipulation process are captured, supporting accurate data collection for training robotic control models.

In some examples, such as the illustrated example, the camera assembly 106 further includes a rear-facing camera 132, which is oriented to capture a field of view extending rearward from the gripper device 100 into the broader environment. The rear-facing camera 132 enables the system to record visual features that are angularly displaced from the forward-projecting axis, including areas behind and to the sides of the device. This configuration allows the camera assembly 106 to achieve a wide-angle or omnidirectional field of view, facilitating robust spatial tracking and mapping even when the workspace is partially or fully occluded. The combination of the front-facing camera 130 and rear-facing camera 132 within the camera assembly 106 provides comprehensive visual coverage, supporting joint SLAM, bimanual coordination, and manipulation tasks performed in confined or cluttered environments.

In some examples, each finger includes a gripping member 112 with an inner surface 114 for gripping objects. The gripping member 112 extends inward from a main body 128 of the finger toward an opposite inner surface 114 of the other finger. A rear end of the main body 128 is coupled to the rotational joint 110, and the main body 128 extends forward to form an outer surface 116 to accommodate the user's fingers or thumb. The fingers or thumb are occluded or obscured from the field of view of the camera assembly 106 by a mask 120 formed from the main body 128 and extending outward above the outer surface 116. The mask 120 incorporates visual tracking features 118 integrally formed into the structure of the main body 128. The visual tracking features 118 present high-contrast fiducial reference points for tracking finger positions and grip width using image data captured by the camera assembly 106. The visual tracking features 118 are arranged in patterns along the fingers, and can be positioned at key points to assist in a visual determination of a grip width or radial position of the fingers, because both fingers are constrained to the same magnitude of radial displacement from a baseline position.

The transmissionless design allows direct actuation of the fingers by the user's thumb and fingers without intermediate mechanisms. In some examples, the common rotational mechanism 108 constrains the fingers to rotate jointly using gears coupled to the rotational joints 110, simplifying the measurement of grip width to a one-dimensional value.

In some examples, the gripper device 100 incorporates an offset angle (e.g., 20 degrees) between the human hand axis and the gripper finger axis to improve ergonomics during tabletop manipulation tasks. Such an angled “pencil grip” design can reduce wrist strain by allowing more natural hand positioning while maintaining precise control of the gripper fingers. This ergonomic feature can enable extended use during data collection with reduced user fatigue.

The transmissionless, rotary joint-based design may reduce mechanical complexity and improve the naturalness and effectiveness of manipulation compared to linear actuation systems. Trigger-based linear actuation, in which a linear actuator squeezes gripping members toward each other, not only displaces the mechanism forward from the user's hand, making manipulation more awkward and less intuitive, but it also provides less precise grip control and haptic feedback to the user. In contrast, the glove-like transmissionless design of the gripper device 100 allows a user to grip objects naturally at a very short distance from the user's hand using motions and relying on haptic feedback that closely emulate natural hand gripping tasks.

In addition, the rotational joints 110 enable a natural and versatile gripping style, in contrast to gripper designs using a pair of parallel gripping members mounted on a linear rail. Not only such a linear parallel gripper more unnatural and less versatile for performing manipulation, but the linear rail presents a wide obstruction of a fixed width at the base on the parallel gripping members, preventing the gripping members from navigating tight spaces (such as insertion deep into a tight cavity) even when fully closed. In contrast, the rotational design of the gripper device 100 allows the fingers to be rotated between a very wide open position suitable for grasping large objects and a very narrow closed position that presents a narrow forward-facing profile.

In some examples, the rotational movement of the fingers is leveraged to provide a multi-antipodal pair of gripping surfaces on the inner surfaces 114 of the gripping members 112. As shown in FIG. 1, each inner surface 114 defines multiple rounded concavities; when the fingers rotate inward and outward, these complementary pairs of concavities face each other at different angles of rotation, defining different antipodal pairs of points on the two surfaces where the surface normal vectors of the two inner surfaces 114 are colinear, enabling an object to be gripped between the complementary antipodal points. For example, a first pair of antipodal points 122 of the largest, rear-most concavity face each other when the fingers are rotated fully inward to a closed position, whereas a second pair of antipodal points 124 face each other when the fingers are rotated fully outward to a fully open position. In the illustrated example, the gripping members 112 include additional, smaller concavities located farther forward, each of which includes multiple such pairs of antipodal points that face each other at different grip widths.

In some examples, the inner surfaces 114 of the gripping members 112 are textured to improve frictional engagement with gripped objects. The gripping members 112 can also be formed from a deformable material, and in some cases may include multiple regions each having a different degree of stiffness or flexibility. When combined with the multi-antipodal pair of gripping surfaces described above, the textured inner surfaces 114 and/or deformable properties of the gripping members 112 can further enhance the frictional engagement with gripped objects as the fingers are rotated toward each other, compressing the deformable material and/or deforming texture protrusions to increase the force and surface area of the gripping members 112 engaging with surfaces of the object.

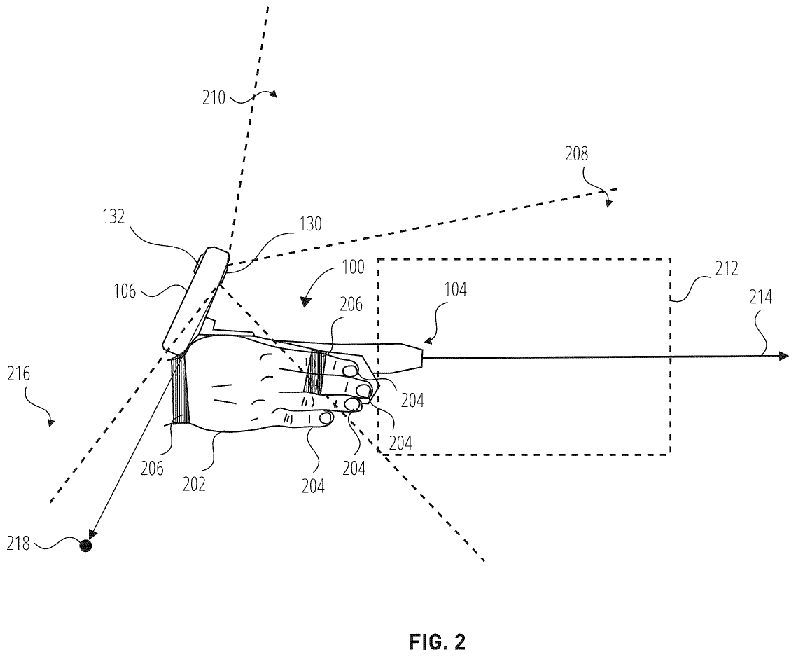

The gripper device 100 may incorporate or exhibit one or more ergonomic features or properties to improve the comfort, ease, and naturalness of manipulations tasks performed by the user's hand. The camera assembly 106 can be positioned such that its center of mass is close to or slightly behind the user's wrist (e.g., directly above a rear portion of the gripper device 100, as shown in FIG. 1). This situation of the camera assembly 106 can provide a counterweight to the fingers and other components of the gripper device 100 to reduce torque applied to the user's hand and/or to reduce the moment of inertia of the gripper device 100, thereby providing a more comfortable and natural balance to the user's hand. A biasing mechanism (not shown) can be included, for example as part of the common rotational mechanism 108, to bias the fingers toward an open position, thus reducing the need for the user's fingers and thumb to actively pull the fingers outward when opening the device's grip. Straps (as shown below in FIG. 2) can be included to couple the fingers to the user's thumb and fingers, and/or to couple the device as a whole to the user's hand or wrist, reducing the need for the user to maintain a grip on the gripper device 100 to prevent it from falling or slipping, and maintaining a firm engagement of the thumb and fingers with the outer surfaces 116. The outer surfaces 116 can include a deformable material, such as a foam layer, to absorb sweat and improve the comfort and reliability of the engagement of the outer surfaces 116 with the thumb and fingers.

In some examples, the fingers incorporate visually compliant regions that deform to provide visual indication of applied forces without requiring force sensors. For example, a deformable honeycomb structure can be formed into an upper surface 126 of the gripping members 112 to be visible by the camera assembly 106. In some examples, a visually compliant region can be included near the fingertips of the fingers to show forces acting near the fingertips. In some examples, a visually compliant region can be included in the upper surface 126 near the inner surface 114 to most effectively show forces acting on the inner surfaces 114. In some examples, the fingers can include regions of varying stiffness, as described above; these regions can include a fingernail structure incorporated into the fingertip to enable hard engagement with objects at the fingertip while maintaining flexibility in the finger as a whole.

The overall design enables intuitive control and haptic feedback while providing visual features necessary for training computational models to control robot manipulators. In some examples, the mechanical components are designed for cost-effective and highly uniform mass production, such as through injection molding. In some examples, the main body 128 of each finger and its corresponding gripping member 112 can be integrally formed together from two different materials (e.g., a more compliant or deformable material for the gripping member 112) via a two-shot injection molding process. Other components, such as brackets and plates for mounting the camera assembly 106 and common rotational mechanism 108, can also be injection molded (e.g., from the same material as the main body 128 of the fingers). Examples of the form and assembly of the various components of the gripper device 100 are described below with reference to FIG. 4.

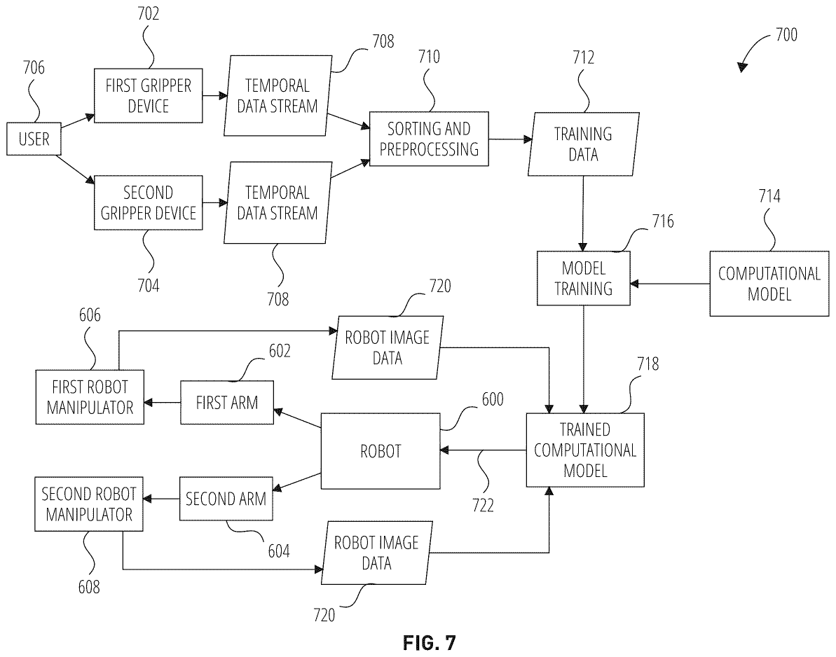

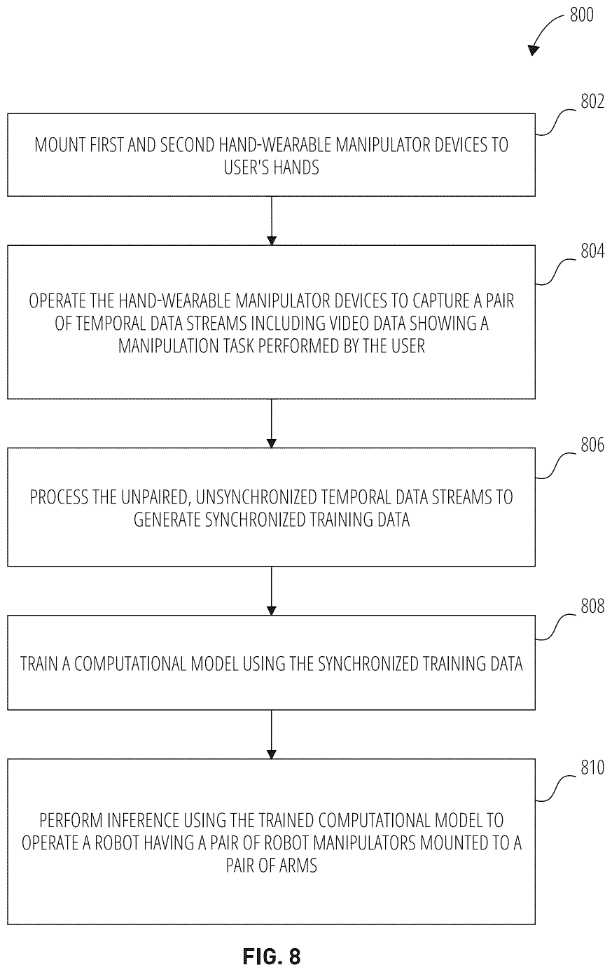

It will be appreciated that the design of the gripper device 100 is ambidextrous, such that the same gripper device 100 can be used in the left hand or right hand. This means that only a single type of device needs to be manufactured, and any one device can be used in place of another. It eliminates the need for left and right hand devices to be paired together and simplifies replacement or substitution of faulty or unavailable devices. In some examples, a collection of gripper devices 100 can be supplied to a data collection team, and any user performing a given manipulation task can use any two of the devices to collect the data. Example systems and methods for data collection and model training, described below with reference to FIG. 7 and FIG. 8, can include a step of automatically pairing and synchronizing data from two devices used in a user's left and right hands to perform the same manipulation task. This pairing can be performed using portions of the data from the two devices, such as synchronized audio cues in audio data captured by a microphone the camera assembly 106, visual cues from the environment embedded in the image data, time stamp data, location data, and so on.

The mechanical features of the gripper device 100 can interact with its sensing features to generate highly detailed image and motion data encoding rich and precise information about the motion of the device, the grip width of the fingers, the forces exerted by objects engaged by the fingers, the appearance of the objects being manipulated, and position of other objects (such as working surfaces) in the workspace. This detailed image and position data can be used to train a model to control a robot to perform the same manipulation tasks using robot manipulators that present a highly similar visual profile to a similarly positioned and configured camera assembly.

In some examples, the gripper device 100 includes markers, such as April grid markers, QR codes, or printed numbers, that are visible to the camera assembly 106 and that encode various metadata including operator identifier codes, collection site identification, task information, and/or hardware version tracking. The encoded information enables automated tracking and organization of data collected from multiple devices and locations.

Thus, in some examples, a system for training a robot 600 includes a gripper device 100 mountable to a user's hand 202. The gripper device 100 includes a first finger (e.g., left finger 102) rotatable inward by a thumb and a second finger (e.g., right finger 104) rotatable inward by other fingers of the hand 202. The camera assembly 106 captures image data over a field of view that includes portions of the fingers and a workspace 212 extending forward from the fingers.

In some examples, the gripper device includes motion sensors, such as an IMU, to generate motion data representative of a motion of the gripper device 100. The motion data can include six-dimensional x-y-z-pitch-roll-yaw information synchronized with image data from the camera assembly.

In some examples, the gripper device 100 includes a common rotational mechanism 108 with gears (shown in FIG. 4 below) that constrain the left finger 102 and right finger 104 to rotate jointly, such that radial positions of both fingers are defined by a one-dimensional grip index. The gears couple to rotational joints 110 to ensure synchronized movement of the fingers.

In some examples, visual tracking features 118 are integrally formed with the fingers through a two-shot injection molding process to present high-contrast fiducial reference points in the field of view of the camera assembly 106. The visual tracking features 118 are arranged in patterns along the fingers to enable precise tracking of finger positions and grip width.

In some examples, the first finger and second finger mirror each other's structure to permit use of the gripper device 100 on either hand, with the first finger becoming the right finger 104 when worn on the left hand and the left finger 102 when worn on the right hand. The mirrored structure enables ambidextrous use while maintaining consistent visual and mechanical properties.

In some examples, the structure of the left finger 102 and right finger 104 are formed by injection molding processes that enable cost-effective mass production while ensuring consistent quality and precise dimensional control needed for reliable operation.

In some examples, the camera assembly 106 is positioned with its center of mass above the user's hand to improve ergonomics by minimizing torque applied to the hand. The positioning of the camera assembly 106 provides a counterweight to the fingers and other components.

In some examples, the gripper device 100 includes a mask 120 to occlude the user's fingers from the field of view of the camera assembly 106. The mask 120 helps match the visual profile of the gripper device to that of a corresponding robot manipulator.

In some examples, the fingers each include a deformable gripping member 112 with an inner surface 114 having multiple stiffness zones, including a fingernail structure at the tip. The inner surfaces define multi-antipodal gripping surfaces that correspond at different grip widths, with textured surfaces for improved grip.

FIG. 2 illustrates a right side view of a user's hand 202 wearing the gripper device 100, showing field of view indicators.

As described above, the gripper device 100 includes the camera assembly 106 mounted above the user's hand 202. The camera assembly 106 captures image data over a field of view which can span various angular ranges. For example, the camera assembly 106 can provide a as part of its full field of view a narrow field of view 208 that shows only a portion of the left finger 102 (not visible in FIG. 2) and right finger 104 of the gripper device 100, along with at least a portion of a workspace 212 in which the manipulation task is being performed. In the illustrated example, the workspace 212 is considered to extend forward from the tips of the fingers of the gripper device 100, centered on a forward-projecting axis 214 of the gripper device 100. The workspace 212 can encompass objects being manipulated as well as the immediate environment of those objects, such as nearby obstructions as well as work surfaces on which the objects rest. The narrow field of view 208 can be configured to include the visual tracking features 118 of the gripper device 100, as well as any visually compliant regions of the device's fingers, in order to improve the usefulness of the image data generated by the camera assembly 106.

In described examples, the full field of view of the camera assembly 106 is a wide-angle field of view, such as a 360-degree field of view (e.g., using a 360-degree camera) or a wide field of view 210 spanning more than 180 degrees, such as more than an entire hemispheric view (e.g., using a wide-angle lens). In some examples, the camera assembly 106 includes multiple cameras, each having its own field of view, and the field of view of the camera assembly 106 is a combined field of view including the field of view of each camera.

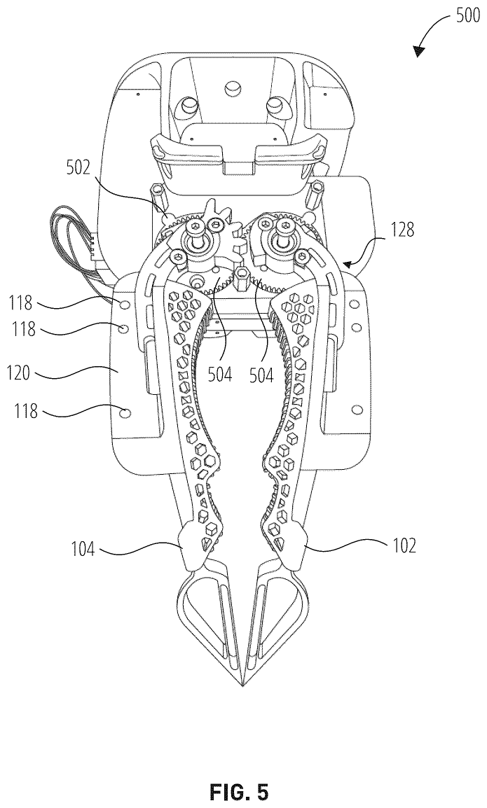

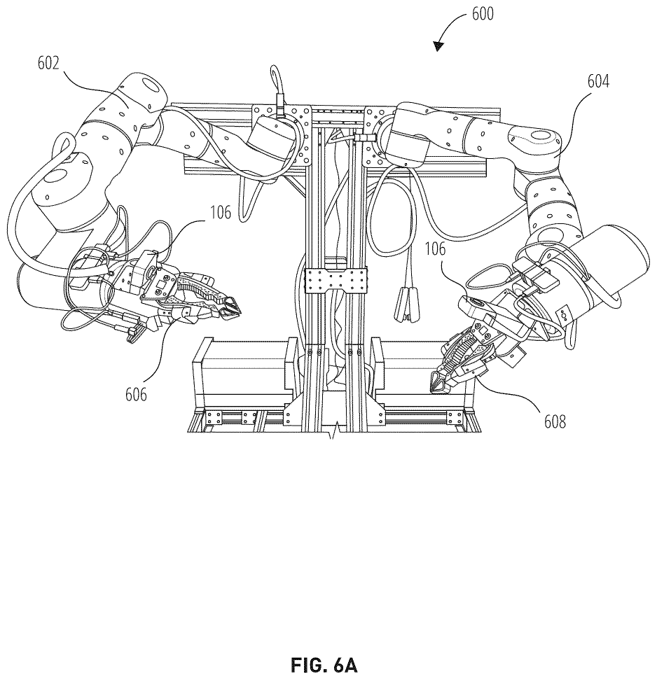

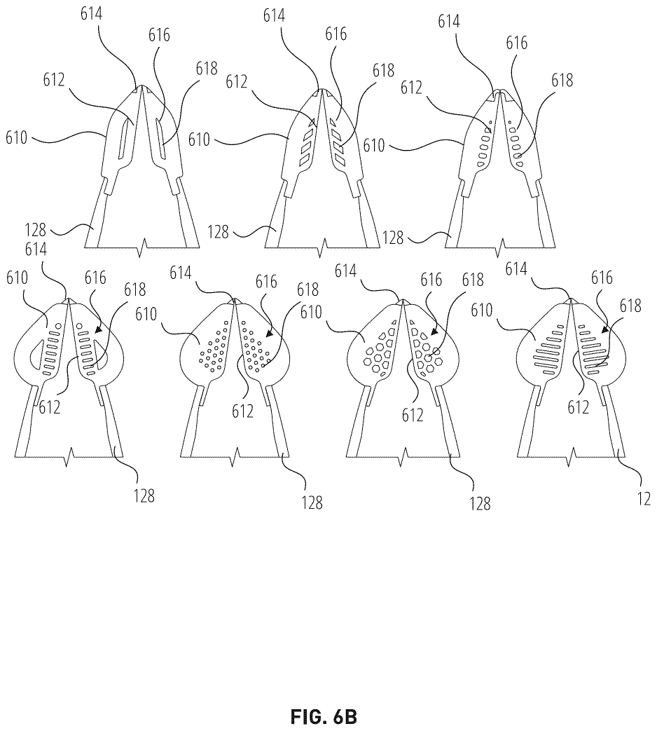

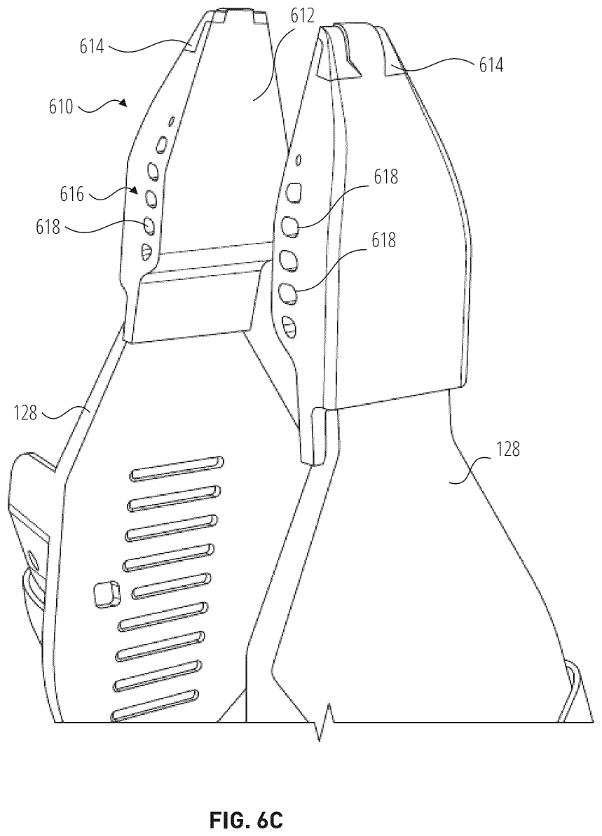

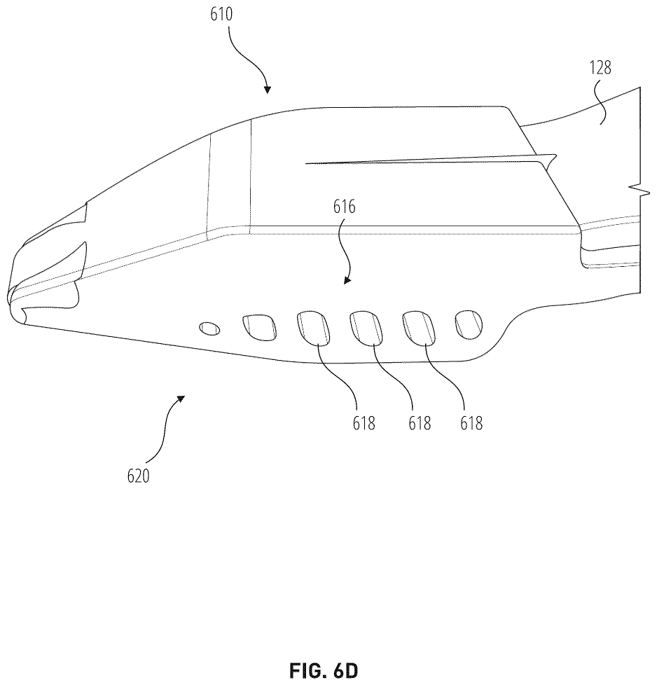

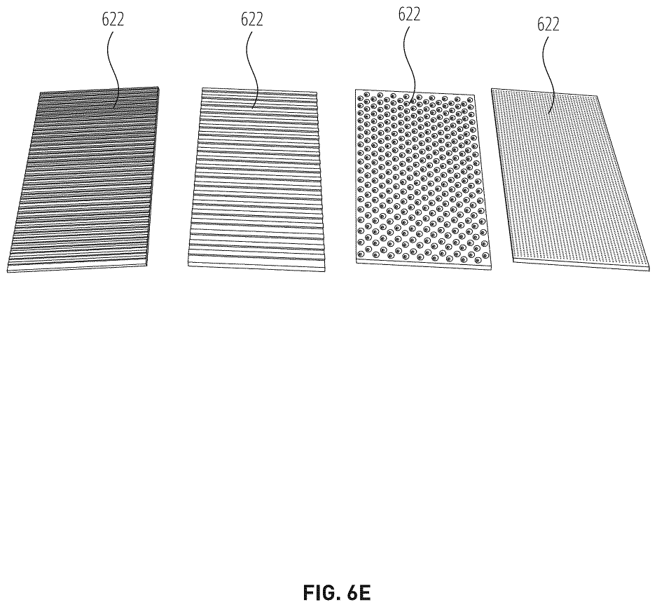

In described examples, the field of view is wide enough to encompass not only the left finger 102, right finger 104, and workspace 212, but also at least a portion of the wider environment 216 around the gripper device 100. For example, the wide field of view 210 can be wide enough to encompass features 218 angularly displaced by more than 90 degrees from the forward-projecting axis 214 extending forward from the gripper device 100. This wide field of view 210 enables the camera assembly 106 to track visual features of the environment 216 such as the ceiling, floor, walls, and other reference surfaces, corners, and points that can assist with SLAM and other visual navigation and mapping operations. In some examples, the camera assembly 106 can be used to capture a very wide field of view (such as 360 degrees in horizontal and vertical planes), and the resulting image data can be preprocessed to mask or filter out irrelevant distractions, such as humans or other moving or dynamic objects visible in the image data. The image data of the region directly around the gripper device 100 can present a visual profile of the device and the manipulation task that is nearly identical to the view of a corresponding robot manipulator (described in greater detail below with reference to FIG. 5 and FIG. 6A-FIG. 6E), in part due to the mask 120 used to occlude the user's thumb and fingers holding the gripper device 100.

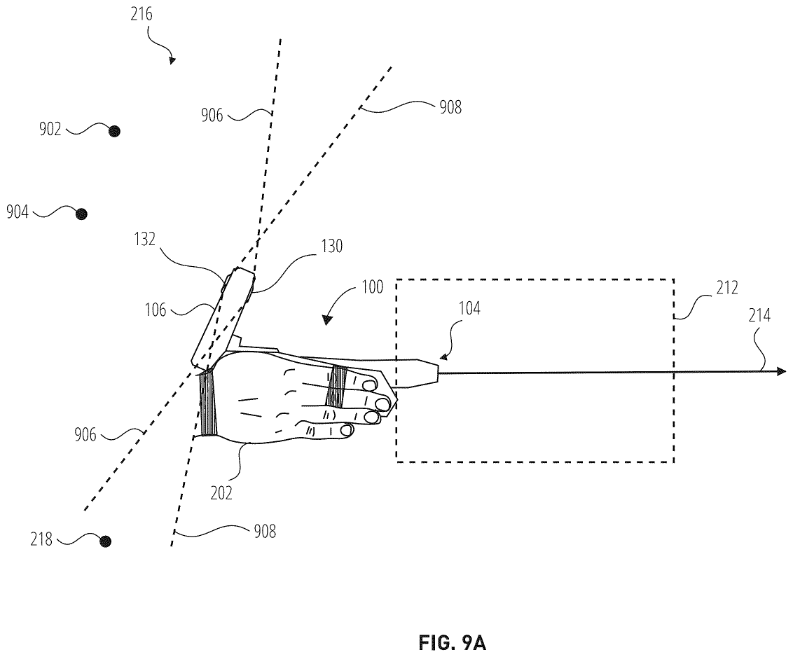

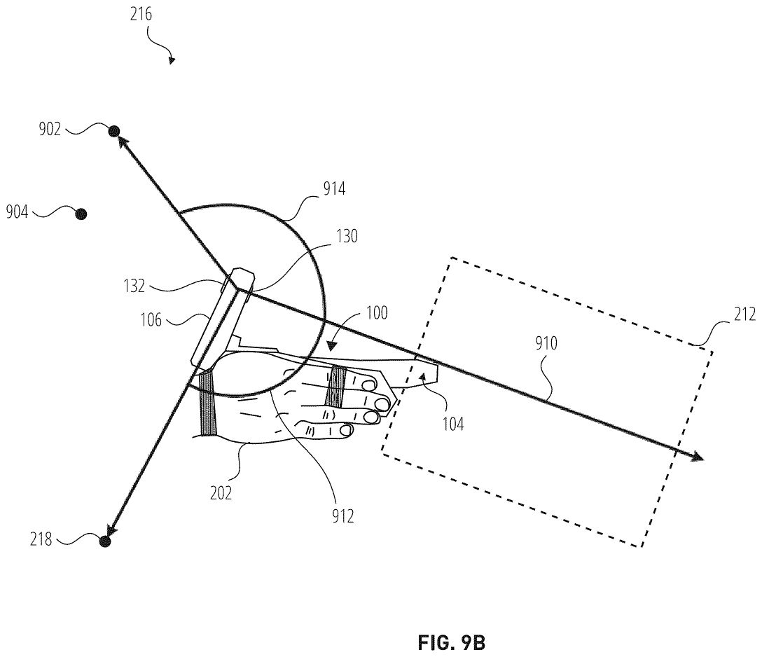

Thus, in some examples, the field of view of the camera assembly 106 includes portions of the environment 216 outside the workspace 212, including features 218 displaced more than 90 degrees from an axis 214 extending forward from the gripper device 100. This expanded field of view enables tracking of environmental features useful for spatial tracking and registration. Further examples of camera assembly fields of view, workspaces, and forward-projecting axes are described below with reference to FIGS. 9A and 9B.

In some examples, as described above, straps 206 can be included in the gripper device 100 to secure the gripper device 100 to the user's hand 202, thumb, and/or one or more fingers 204. The straps 206 may include a strap to secure the device's right finger 104 to one or more of the user's fingers 204, a strap (not visible) to secure the left finger 102 (not visible) to the user's thumb, and/or a strap 206 to secure the gripper device 100 to the wrist or palm of the user's hand.

In some examples, the straps 206 include a strap to secure the first finger of the gripper device 100 to the hand 202, a strap to secure the second finger of the gripper device 100 to one or more fingers of the hand 202, and a strap to secure the gripper device to the wrist or palm of the hand 202. The multiple straps ensure secure mounting while maintaining natural movement.

Thus, in some examples, the gripper device includes a biasing mechanism to bias the first finger and second finger away from each other, and straps 206 to secure the device to the user's hand 202. The biasing mechanism reduces user fatigue while the straps maintain secure engagement.

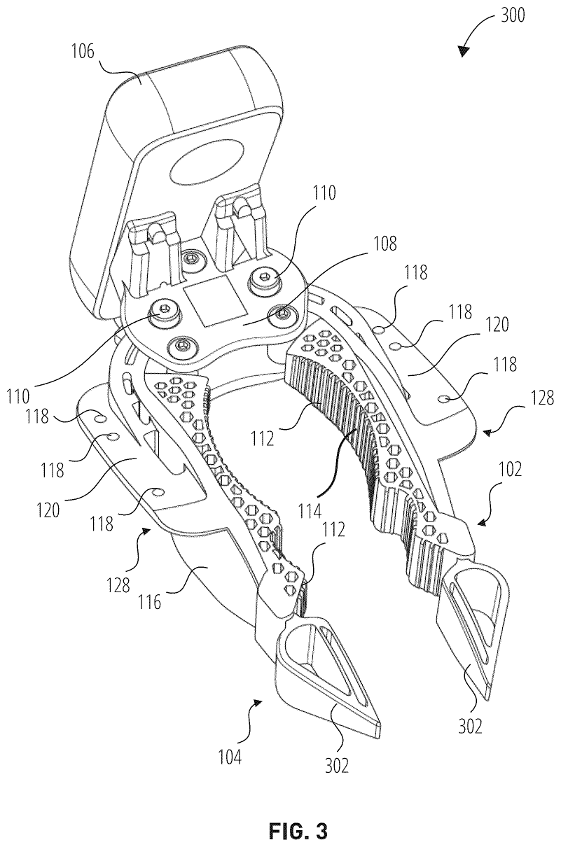

FIG. 3 illustrates a perspective view of an alternative gripper device 300 having many of the same features as the gripper device 100 of FIG. 1, similarly numbered in FIG. 3.

The gripper device 300 features specialized fingertips 302. In some examples, the fingertips 302 are formed from a stiffer material than the gripping members 112 and define visually compliant regions that visibly deform in response to forces acting on the fingertips 302.

It will be appreciated that the overall design of the gripper device can be varied while still exhibiting many or all of the features described above with reference to the gripper device 100. However, it is important for any design for the gripper device (e.g., gripper device 100 or gripper device 300) to visually and mechanically correspond to its robot manipulator counterpart in order to ensure reliable and accurate control of the robot based on the image data captured by the robot's cameras.

FIG. 4 illustrates an exploded view of components of the gripper device 300. It will be appreciated that gripper device 100 includes similar components, similarly assembled.

The gripper device 300 is formed from a modular assembly of injection-molded components, including a camera bracket 406 for mounting the camera assembly 106, a base plate 410 for assembling the common rotational mechanism 108, and the fingers (left finger 102 and right finger 104). As described above, in some cases the fingers are formed by a two-shot injection molding process, with a first material used for the main body 128 and a second material used for the gripping member. In some examples, the base plate 410 and/or camera bracket 406 can be injection molded from the same material as the main body 128 of the fingers.

In some examples, the common rotational mechanism 108 includes metal gears 402 that constrain the fingers to rotate jointly. The gears 402 are coupled to the rotational joints 110 to ensure synchronized movement of the fingers. Multiple spacers 404 are positioned between components to maintain proper alignment and spacing. In some examples, the spacers 404 are machined from metal. The common rotational mechanism 108 can include a biasing mechanism (not visible), such as a spring, engaging the gears 402 or another component coupled to the fingers to bias the fingers to an open position.

The assembly of the gripper device 300 includes foam 408 providing padding on the outer surfaces 116 of the fingers to contact the user's hand to improve comfort and grip. The foam 408 may be die-cut to precisely fit the contours of the outer surfaces 116 of the fingers.

The camera assembly 106 mounts to the camera bracket 406, which can be designed to position the camera's center of mass above the user's hand. The base plate 410 provides structural support and mounting points for the other components.

In some examples, the two-shot injection molding process used to form the fingers (102, 104) also integrally forms the visual tracking features 118 and visually compliant regions of the fingers using visually contrasting materials, such as yellow for the tracking features and gripping members 112, and black for the main body 128 of the fingers (including the mask 120). This manufacturing approach can eliminate the need for separately applied markers or grip surfaces.

The modular design enables cost-effective mass production and easy assembly/maintenance. The use of injection molding for key components ensures consistent quality and precise dimensional control needed for reliable operation of the gearing mechanism and visual tracking features.

FIG. 5 illustrates a top view of a robot manipulator 500 corresponding to the gripper device 300 of FIG. 3.

The robot manipulator 500 conforms closely to the mechanical behavior, structural form, and visual profile of the gripper device 300, thereby enabling a model training using data from gripper devices 300 to be used to control a robot equipped with robot manipulators 500 relying on image data from a camera assembly 106 mounted to each robot manipulator 500.

The robot manipulator 500 includes an actuator 502 for actuation by the robot. In some examples, the actuator 502 includes low-backlash gears 504 that constrain rotation of the fingers (102, 104) to joint rotation, like the common rotational mechanism 108 of the gripper device 100 or gripper device 300. However, the use of low-backlash gears 504 in the actuator 502 enables precise control of finger positions while maintaining the same one-dimensional grip width constraint as the common rotational mechanism 108 of the gripper device 300.

The fingers (102, 104) can be manufactured using the same injection molding process as the fingers of the gripper device 300 to ensure consistent appearance and behavior. The fingers incorporate visual tracking features 118 and a mask 120 that are visually identical to those of the gripper device 300 to maintain a matching visual profile when viewed by the robot's camera system.

In some examples, the robot manipulator 500 is designed to be hardware-agnostic, enabling deployment across different robot platforms while maintaining the same mechanical and visual properties that correspond to the gripper device 300. This correspondence between the human-operated gripper device and robot manipulator enables reliable transfer of demonstrated manipulation behaviors to the robot system.

Thus, in some examples, a robot manipulator 500 includes a pair of robot manipulator fingers constrained by low-backlash gears 504, a camera assembly matching the gripper device 100, and visual tracking features integrally formed in the fingers. The robot manipulator 500 matches the mechanical and visual properties of the gripper device to enable reliable transfer of demonstrated behaviors.

FIG. 6A illustrates a front view of a robot 600 with two arms equipped with robot manipulators, such as the robot manipulators 500 shown in FIG. 5.

The robot 600 includes a first arm 602 and a second arm 604 mounted to a support structure. A first robot manipulator 606 (e.g., a robot manipulator 500) is mounted to the first arm 602, and a second robot manipulator 608 (e.g., another robot manipulator 500) is mounted to the second arm 604.

As described above with reference to FIG. 5, the robot manipulators (606, 608) are designed to match the visual and mechanical properties of the gripper devices (e.g., 100 or 300) described in previous figures. Each manipulator incorporates identical injection-molded fingers with the same visual tracking features and mask design as the gripper device to maintain a matching visual profile when viewed by the robot's camera system.

In FIG. 6A, camera assemblies 106 can be seen mounted to the manipulators (606, 608). The camera assemblies 106 can be mounted to match their position on the corresponding gripper device, such that the image data from each of the robot's camera assemblies 106 is a visual match to the image data collected from a gripper device used to perform the same manipulation task. In some examples, the field of view of the camera assemblies 106 can be the same on the gripper device and the corresponding robot manipulator; in other examples, the field of view may differ between the two devices, and may be aligned or reconciled by filtering, cropping, or otherwise adjusting the image data from the gripper device (prior to training) and/or the robot manipulator (prior to providing the image data as input to the trained model during inference and robot control).

The robot 600 demonstrates the hardware-agnostic nature of the manipulator design. The robot manipulators can be mounted to different robot arm platforms while maintaining the same mechanical and visual properties that correspond to the gripper devices. The model can be trained to reproduce the manipulation task in the context of the robot 600 by translating the model output to a control scheme for the robot arms, which generally allows the position of the robot's arms and the actuators for the manipulators to be precisely controlled to match hand position and grip width outputs of the model. This correspondence between the human-operated gripper devices and robot manipulators enables reliable transfer of demonstrated manipulation behaviors to the robot system, regardless of the details of the robot's specific control scheme.

The dual-arm configuration allows the robot 600 to perform bimanual manipulation tasks that have been demonstrated using a pair of gripper devices. The robot 600 preserves some or all of the mechanical advantages of the gripper device design, including the transmissionless rotary actuation and precise grip width control through low-backlash gearing.

FIG. 6B illustrates a top view of different designs for fingertips 610 for a gripper device and robot manipulator with various honeycomb structures 618 providing a visually compliant region and with various fingernail structures.

In each example design, the fingertips 610 incorporate specialized features including a pad 612 and a fingernail structure 614. The pad 612 comprises a visually compliant region 616 with honeycomb structures 618 that deform in response to applied forces.

The fingertips 610 can be manufactured through a two-shot injection molding process using two different materials—in some examples, a yellow or orange deformable material is used for the visually compliant regions 616, and a stiffer, differently-colored (e.g., black) material is used for the main body 128 and the fingernail structures 614. This manufacturing approach enables the honeycomb structures 618 to be integrally formed into the fingertip design rather than added afterward.

The visually compliant regions 616 are strategically positioned to be visible in the field of view of the camera assembly, providing visual indication of forces applied during manipulation tasks without requiring force sensors. The honeycomb structures 618 are designed to deform in predictable patterns that can be tracked by the camera system. In some examples, the honeycomb structures 618 also contribute to the deformation patterns of the fingertips 610 to improve gripping or pushing engagement with objects.

Multiple fingertip designs are shown with varying patterns of honeycomb structures 618, enabling different types of force visualization and gripping capabilities. The designs incorporate both fine manipulation features through the fingernail structure 614 and compliant gripping through the deformable pad 612.

Thus, in some examples, the fingers include visually compliant regions 616 with honeycomb structures 618 that visibly deform in response to forces applied during gripping operations. The honeycomb structures 618 are designed to deform in predictable patterns that can be tracked by the camera system. The deformation patterns provide visual indication of applied forces without requiring separate force sensors.

FIG. 6C illustrates a perspective view of fingertips 610 of a gripper device or robot manipulator with honeycomb structures and fingernail features. The example shown in FIG. 6C corresponds to one of the example designs shown in FIG. 6B, from a perspective view showing the inner surface of the pad 612.

FIG. 6D illustrates a perspective view of a visually compliant region of a fingertip 610 of a gripper device or robot manipulator showing honeycomb structures deforming in response to force from engaging a surface 620, such as a tabletop or other work surface.

The example shown in FIG. 6D corresponds to the fingertip design shown in FIG. 6C. The honeycomb structures 618 visibly change their shape to show horizontal shearing forces and downward forces of the fingertip 610 against the surface 620.

FIG. 6E illustrates different examples of grip surface textures 622 for the inner surfaces of the gripper device fingers.

The grip surface textures 622 include various patterns such as horizontal ridges, vertical ridges, checkerboard patterns, and arrays of rounded bumps or other protrusions, all arranged at various periodicities and having various dimensions. These different textures are manufactured through the injection molding process to provide varying levels of frictional engagement with objects being manipulated.

The textured surfaces can be formed from the same deformable material (e.g., a yellow or orange deformable polymer material) used for the visually compliant regions and tracking features of the fingers, contrasting with the differently-colored (e.g., black) main body. The textures can be integrally formed during the manufacturing process rather than being added afterward, e.g., by a two-shot injection molding process.

The different patterns of the textures 622 can enable improved gripping capabilities for different types of manipulation tasks. When combined with the multi-antipodal gripping surfaces and deformable materials of the fingers, these textured surfaces can enhance frictional engagement as the fingers rotate toward each other during gripping operations.

FIG. 7 illustrates a block diagram of a system 700 for training a computational model 714 to operate a robot 600 using data collected from hand-wearable manipulator devices (such as gripper device 100 or gripper device 300).

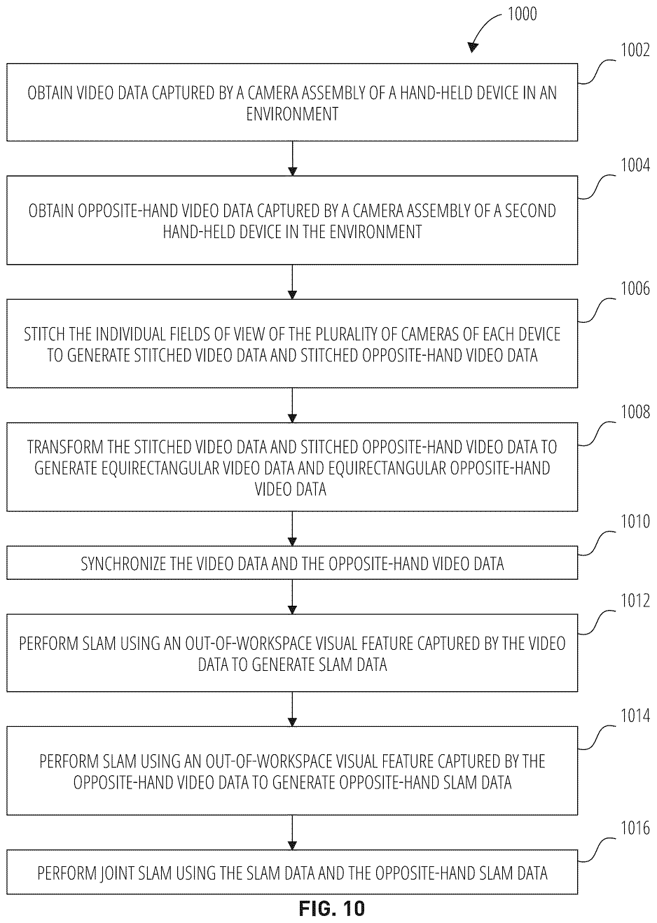

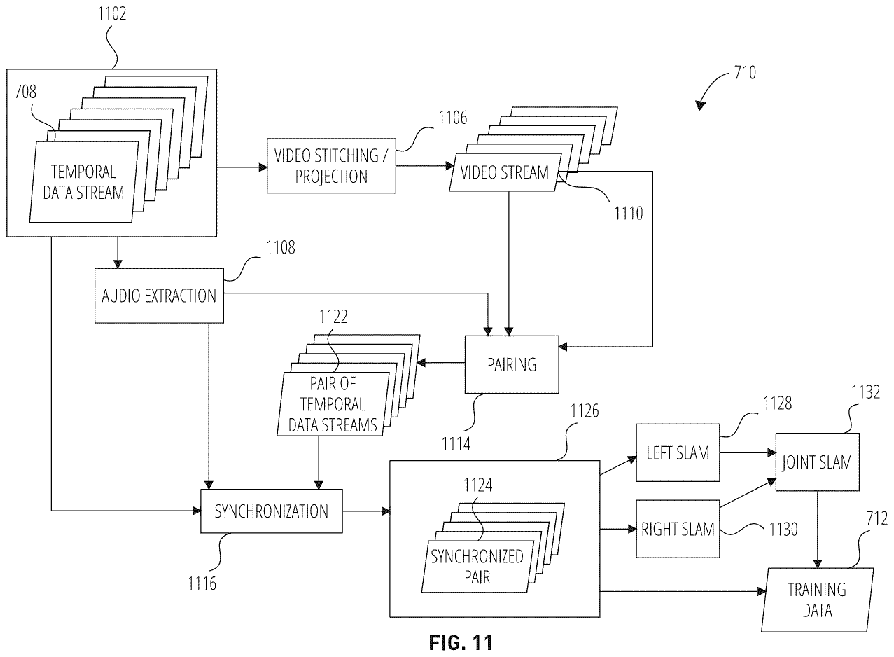

A user 706 operates a first hand-wearable manipulator device (shown as first gripper device 702) in a left hand and a second hand-wearable manipulator device (shown as second gripper device 704) in a right hand to generate temporal data stream 708 (including video data as well as, in some cases, additional data such as motion data from an IMU, audio data from a microphone, location data, time stamp data, device identifier data, user identifier data, task identifier data, data owner identifier data, and so on). The temporal data streams 708 from both devices are collected and provided to a sorting and preprocessing stage 710. In some examples, the sorting and preprocessing stage 710 automatically pairs and synchronizes the data streams from the first gripper device 702 and second gripper device 704 used for a given manipulation task based on the received data. In some examples, the sorting and preprocessing stage 710 receives inputs of a large number of data streams from a large number of gripper devices being used to collect training data, and the sorting and preprocessing stage 710 includes a specialized algorithm to sort and match data from pairs of devices used jointly for a given task. For example, the sorting and preprocessing stage 710 can be performed on a computing system receiving hundreds or thousands of packages of data from individual devices sent over a network, or read from tangible media such as memory cards, each package representing the data collected by a single gripper device during one or more manipulations tasks. Details of example sorting and preprocessing stages 710 and their operations are described below with reference to FIG. 10 and FIG. 11.

In some examples, the sorting and preprocessing stage 710 can process the temporal data stream 708 of each device to perform SLAM, and the spatial maps generated by SLAM can be used to pair the data from the two devices used on the left and right hands of the user 706. In some examples, this pairing or matching is performed after filtering the data using rough filtering criteria, such as user identifier data, time stamp data, and/or geographic location data. It will be appreciated that various techniques can be used to sort and match the pairs of data streams from individual devices to identify pairs of devices jointly performing a task in the same place at the same time on the hands of the same user 706.

In some examples, the system 700 automatically pairs corresponding left and right hand video files from a large collection using both visual and audio features extracted from the recordings. The pairing process performed by the sorting and preprocessing stage 710 can analyze scene content, timing information, and/or synchronized audio cues to identify videos captured simultaneously during the same manipulation task. This automated approach can enable efficient processing of data from large device fleets without requiring manual tracking of device pairs or recording sessions.

In some examples, the sorting and preprocessing stage 710 uses algorithms or machine learning models trained or configured to automatically determine whether video data was captured from a left hand or right hand device based on visual characteristics of the manipulation tasks. This automated hand classification operation allows the manufacturing of ambidextrous gripper devices that can be used interchangeably on either hand, as described above, thereby simplifying production and deployment. The right-left classification capability of the sorting and preprocessing stage 710 can support scaling to large numbers of devices by eliminating the need to manually track and pair specific left and right hand units.

After two data streams are paired, the sorting and preprocessing stage 710 performs further preprocessing of the data to prepare it for use in the training process. In some examples, audio data or other data sources can be used to synchronize the paired data streams, e.g., by temporally aligning a pair of corresponding audio cues (such as a loud clapping sound or other acoustically distinct sound used to initiate a data collection session). In some examples, distracting content can be filtered from the video data of the temporal data streams 708, such as moving objects (including humans) shown in the field of view of the camera assembly. In some examples, any portions of the user's hands extending beyond the mask 120 can be visually masked or filtered out of the video data of a temporal data stream 708 to more closely match the visual profile of the gripper device to a visual profile of the robot manipulators to be used by the robot.

In some examples, the system masks out humans or other moving objects from the camera images before performing SLAM processing, because some SLAM algorithms operate most effectively on static environments. The masking process removes dynamic elements that could otherwise interfere with accurate spatial tracking. This approach can improve the robustness and reliability of the SLAM operations for data collected in environments with human activity.

In some examples, SLAM is performed for the first time or for a second time after the data streams are paired; for example, a joint SLAM operation performed after pairing can include generation of a spatial map that includes the position of both gripper devices within the mapped space. The sorting and preprocessing stage 710 can perform SLAM by jointly processing data from both left and right hand cameras (and motion sensors) to generate a unified spatial map. The use of joint SLAM processing can improve tracking accuracy for each hand by incorporating visual features observed from multiple perspectives into a single consistent representation of the environment. This approach can reduce the need for external fiducial markers by leveraging naturally occurring environmental features like corners of walls, floors, and ceilings that are visible in the expanded field of view of both cameras.

In addition to SLAM data, the sorting and preprocessing stage 710 can generate other types of data by processing the video data, such as a stream of grip width data for each gripper device (based on the video data from each camera assembly), a stream of visual deformation parameters relating to the visually compliant regions of each gripper device, etc. In some examples, the video data of the temporal data streams 708 is transformed in various ways by the sorting and preprocessing stage 710, such as cropping, downsampling, filtering, etc.

In some examples, the sorting and preprocessing stage 710 performs calibration and tracking preprocessing operations that convert the observed positions of the visual tracking dots into precise radian values representing the grip width. The tracking operations can account for camera perspective and finger geometry to maintain accurate measurements across the full range of motion. These radian values provide a standardized representation of grip states that can be directly mapped to robot manipulator control; in some examples, these radian values can be provided to the model during training to supplement the preprocessed temporal data stream 708.

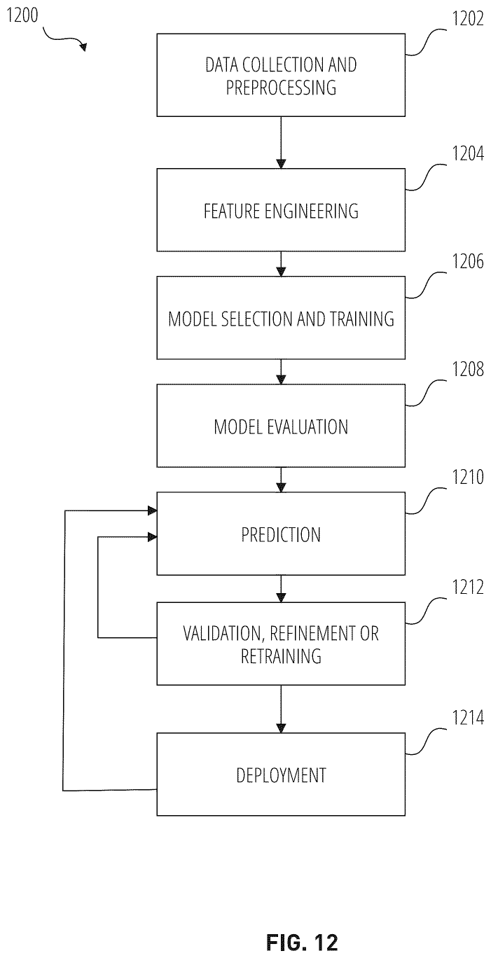

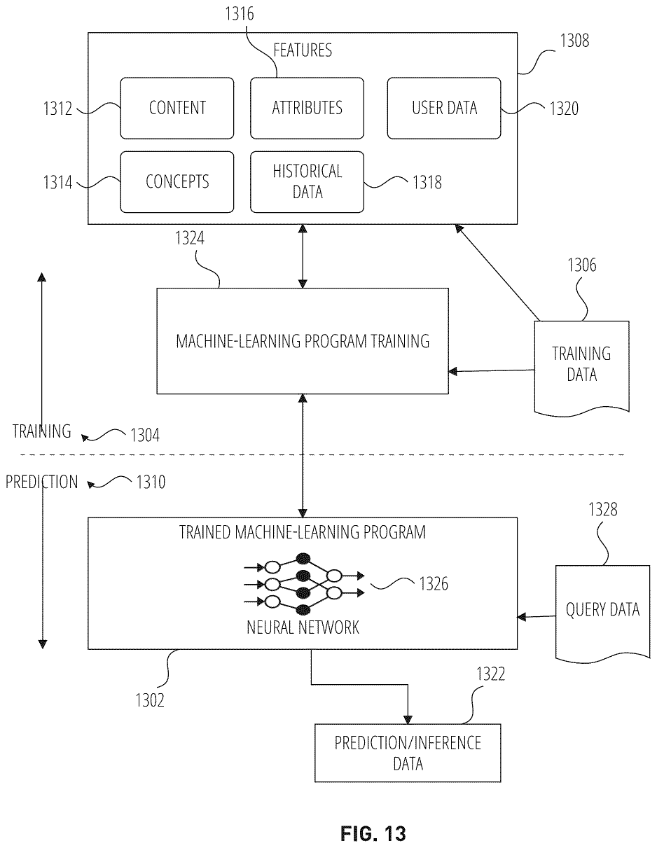

After the sorting and preprocessing stage 710 completes its sorting and preprocessing operations, the resulting preprocessed data is stored as training data 712 that is used by a model training stage 716 to train a computational model 714. The model training stage 716 trains the computational model 714 to produce a trained computational model 718. The training incorporates feature engineering to extract relevant information from the temporal data stream 708, and to adjust learnable parameter values of the computational model 714 to generate a trained computational model 718 trained to perform the manipulation task shown in the training data 712 based on robot data input streams formatted to match the training data 712. An example machine learning pipeline, describing general approaches that can be used to train a computational models such as the computational model 714, is described below with reference to FIG. 12 and FIG. 13.

After training is complete, the trained computational model 718 is deployed to perform inference by operating a robot 600. During inference, the trained computational model 718 receives robot image data 720 from a first robot manipulator 606 (such as robot manipulator 500) mounted on a first arm 602 of the robot 600 and a second robot manipulator 608 mounted on a second arm 604 of the robot 600. The trained computational model 718 processes the robot image data 720 (and optionally other data, such as IMU motion data) as inputs to generate output control data 722 to operate the robot manipulators. The robot manipulators match the mechanical and visual properties of the gripper devices to enable reliable transfer of demonstrated behaviors.

In some examples, the data received from the robot manipulators is preprocessed in various ways to match its format and content to the format and content of the training data 712 used to train the model. For example, a field of view of the robot image data 720 can be cropped, and/or the robot image data 720 can be filtered or resampled, to match the image data format on which the model was trained. The robot image data 720 can be processed to generate grip width data and/or visual deformation data for input to the model to match corresponding inputs from the training data 712. Other preprocessing of the robot sensor data, such as SLAM operations, can be performed to generate other inputs to the trained computational model 718 for generating the control data 722.

In some examples, the control data 722 encodes a temporal stream of spatial coordinates for movement of the robot manipulators, including SLAM data, a grip width value, and/or motion data for each robot manipulator (e.g., six-dimensional x-y-z-pitch-roll-yaw information). The individual robot platform used to implement the robot 600 can translate this coordinate and grip width data into control signals for individual effectors or actuators to move the arms (602, 604) and actuators 502 to achieve the desired positions of the robot manipulators (606, 608).

The system 700 provides an automated pipeline for collecting demonstration data at scale. The pipeline handles tasks such as pairing corresponding left and right hand data, synchronizing video streams, and masking out humans from the video data to improve spatial tracking robustness. The trained model can then control robot manipulators across different platforms while maintaining consistent manipulation capabilities.

The various operations and stages of the system 700 can be implemented using suitable combinations of hardware and software to automate the collection, sorting, and preprocessing of training data, the training of models to perform specific manipulations tasks, and the deployment and control of robots 600 equipped with trained computational models 718 for performing the manipulations tasks. In some examples, computer-readable media can include instructions and other data (such as the computational model 714 or trained computational model 718) to automate the collection and sorting of training data, the training of computational models using the captured data, and the use of the trained models to control robots.

In some examples, a non-transitory computer-readable storage medium includes instructions that, when executed, cause a system to control a robot using a trained computational model. The model is trained using data captured by gripper devices during manipulation tasks, enabling the robot to replicate demonstrated behaviors.

Example methods, described below with reference to FIG. 8, include automated preprocessing of the training data and deployment of trained models across different robot platforms.

FIG. 8 illustrates a flowchart of operations of a method 800 for training a computational model to operate a robot using data from hand-wearable manipulator devices.

Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

The method 800 is described below with reference to the example gripper devices (100 or 300) and robot manipulators 500 described herein as part of the example system 700. However, it will be appreciated that some examples of the method 800 can be performed using devices, systems, and techniques that differ from those described above.

The method 800 includes an operation 802 of mounting first and second hand-wearable manipulator devices (such as gripper devices 100) to a user's hands. The gripper devices (e.g., 100 or 300) can include rotatable fingers actuated by the user's thumb and fingers, and camera assemblies to capture video data of manipulation tasks. In some examples, the video data includes data captured by multiple cameras of the camera assembly. In some examples, the gripper devices also capture audio data and/or motion data temporally aligned to the video data.

In operation 804, the gripper devices are operated by the user to capture a pair of temporal data streams including video data showing a manipulation task performed by the user. The camera assemblies capture both the manipulation workspace and environmental context while the user performs demonstration tasks. In some examples, additional data can be captured as well, as described above.

In operation 806, the unpaired, unsynchronized temporal data streams are processed to generate synchronized training data. In some examples, this operation 806 can be performed by the sorting and preprocessing stage 710. Detailed examples of sub-operations of operation 806 are described below with reference to FIG. 10, and detailed examples of sub-components of the sorting and preprocessing stage 710 are described below with reference to FIG. 11.

Operation 808 involves training a computational model using the synchronized training data. The training process can include feature engineering to extract relevant information from the visual and sensor data streams collected during the demonstrations and secondary data derived therefrom by operation 806. This extracted information is used to adjust learnable parameter of a computational model 714 to generate a trained computational model 718. In some examples, the image data is sorted, preprocessed, and/or combined with additional data to generate the training data 712 used to train the model, as described above.

In operation 810, inference is performed using the trained computational model to operate a robot having a pair of robot manipulators mounted to a pair of arms. The robot manipulators match the mechanical and visual properties of the gripper devices to enable reliable transfer of demonstrated behaviors. The trained model processes robot image data to generate control signals for operating the robot manipulators to perform manipulation tasks, relying on visual feedback (and/or other feedback) generated by the robot 600 and the cameras and other sensors of the robot manipulators 500.

The method 800 enables automated collection and processing of demonstration data to train robots to perform manipulation tasks. The end-to-end pipeline handles tasks such as pairing corresponding left and right hand data, synchronizing video streams, masking out distractors from the video data to improve spatial tracking robustness, generating supplemental data (e.g., SLAM, grip width) to assist the training and inference processes, etc.

FIG. 9A shows a right side view of the gripper device 100 worn on the user's hand 202, as in FIG. 2. FIG. 9A illustrates further details of the configuration and operation of the camera assembly 106, which includes the front-facing camera 130 and rear-facing camera 132 in the illustrated example. Specifically, FIG. 9A presents the arrangement of these two cameras to capture a joint field of view that extends beyond the workspace 212 and includes various visual features angularly displaced by more than 90 degrees from the axis 214.

In some examples, the front-facing camera 130 and rear-facing camera 132 are interconnected within the camera assembly 106. The cameras can be synchronized by a common data acquisition subsystem, which aligns image data streams for subsequent processing. In some examples, the fields of view of the cameras can be automatically combined not a unified field of view by subsystems within the camera assembly 106 itself. It will be appreciated that these features can be applied to a camera assembly 106 having two cameras (such as 130 and 132) or more than two cameras.

In some examples, the positioning of the camera assembly 106 can be selected to maximize the coverage of both the workspace 212 and the surrounding environment 216, while maintaining ergonomic balance for the user's hand 202.

The joint field of view is defined by the combined coverage of the front-facing camera 130 and rear-facing camera 132. The front-facing camera 130 has a wide-angle front camera field of view (spanning a right-facing arc between the two dashed lines 906) that captures the workspace 212, which in the illustrated example is centered on axis 214 extending forward from the tips of the fingers of the gripper device 100. As shown in FIG. 9A, feature 218 is just outside of a hemispheric view centered on an optical axis of the front-facing camera 130. However, because the front camera field of view of the front-facing camera 130 encompasses over 180 degrees, the feature 218 is visible by the front-facing camera 130.

The rear-facing camera 132 has a wide-angle rear camera field of view (spanning a left-facing arc between the two dashed lines 908) that captures regions of the environment 216 that are located behind and/or to the sides of the gripper device 100. As shown in FIG. 9A, the feature 218 is also visible within the rear camera field of view, as well as a second feature 902 and third feature 904 located to the rear of the gripper device 100. These features can include corners, points, or surfaces in the environment 216, such as ceilings, floors, and walls.

The camera assembly 106 is thereby provided with a joint field of view encompassing the union of the front camera field of view and the rear camera field of view, which is a full spherical omnidirectional FOV in the illustrated embodiment. This joint field of view includes visual feature 218, second feature 902, and third feature 904, as well as the workspace 212, even when the features 218, 902, and/or 904 are displaced from the forward-projecting axis 214 by a relatively wide angle (such as more than 90 degrees or more than 135 degrees).

The configuration shown in FIG. 9A enables the capture of visual features that are not accessible to a single forward-facing camera. By using a two-camera camera assembly 106 with overlapping or complementary fields of view, the system can use the video data from the camera assembly 106 to track environmental features that are angularly displaced from the workspace 212, supporting SLAM and spatial analysis. The joint field of view can be used to generate unified spatial maps and bimanual trajectory data for robotic data collection and training.

FIG. 9B shows a further example of the right side view of the user's hand 202 wearing the gripper device 100, as in FIG. 2 and FIG. 9A. FIG. 9B provides further examples of the angular displacement of visual features 902, 904, and 218 from a different example of the forward-projecting axis 910. The figure illustrates the spatial relationship between the workspace 212, the camera assembly 106, and environmental features captured at wide angular displacements.

In FIG. 9B, the forward-projecting axis 910 projects forward along the optical axis of the front-facing camera 130 and thereby defines the workspace 212 as being centered on this optical axis. It will be appreciated that the workspace 212 can be defined by any generally forward-projecting axis of the gripper device 100 passing through the center of a space in which objects of interest to the manipulation task are likely to be visible. Thus, various examples may define the forward-projecting axis and the workspace 212 differently from those illustrated herein.

Visual features 218 and 902 are shown as being angularly displaced from the axis 910 by a first angle 912 and a second angle 914, respectively. In some examples, the first angle 912 represents an angular displacement of slightly more than 90 degrees from the axis 910, and the second angle 914 represents an angular displacement of slightly more than 135 degrees from the axis 910. Although not shown, the third feature 904 is displaced nearly 180 degrees from the axis 910. The illustrated camera assembly 106 is configured to capture features at these wide angular displacements, enabling the inclusion of environmental context that may not be visible to a traditional forward-facing camera.

FIG. 10 shows a flowchart overview of a method 1000 for automatically processing video data from camera assemblies 106 of two hand-held devices to generate robotic training data. The sequence of operations depicted in FIG. 10 may be modified, with certain operations performed in parallel or in a different order, without affecting the technical function of the method 1000.

At operation 1002, video data is obtained from a camera assembly 106 of a first handheld device, such as gripper device 100. The camera assembly 106 can include a plurality of cameras (e.g., 130 and 132) or a single wide-angle camera, as described above. The camera assembly 106 is configured to capture a field of view encompassing a workspace 212 and at least one visual feature 218 of the environment 216 that is angularly displaced by at least 90 degrees from a forward-projecting axis (e.g., 214 or 910).

At operation 1004, opposite-hand video data is obtained from a camera assembly of a second hand-held device in the same environment 216. The second camera assembly can be implemented with similar or different camera configurations and interfaced with the second hand-held device to capture complementary visual information. In some examples, the first hand-held device and second hand-held device are held by the left and right hands of the same user while performing a single two-handed manipulation task.

At operation 1006, the individual fields of view from multiple cameras of each device are stitched to generate stitched video data (from the first hand-held device) and stitched opposite-hand video data (from the second hand-held device). A video stitching subsystem can receive raw video streams from the two or more cameras of a given device and output a unified panoramic or wide-angle view for the device. In examples using a single wide-angle camera for the camera assembly 106, operation 1006 can be omitted.

At operation 1008, the stitched video data and stitched opposite-hand video data are transformed into equirectangular video data and equirectangular opposite-hand video data. This transformation projects the panoramic or wide-angle views onto a two-dimensional plane in a rectangular shape, enabling compatibility with standard computer vision and SLAM algorithms that operate on rectangular pixel arrays.

Although not shown in FIG. 10, some examples perform a masking operation to mask dynamic objects out of the video data from one or both devices. This masking operation can be performed at various stages in the video processing pipeline, such as before operation 1006, before operation 1008, or before operation 1010. In some examples, as described above, a trained machine learning model (such as an image segmentation model) can be used to mask out dynamic objects such as the user, other humans, blinking lights, and/or other moving or visually dynamic objects from the video frames. This can improve the robustness and reliability of spatial tracking, particularly in environments with significant human activity or dynamic elements.

At operation 1010, the video data is synchronized with the opposite-hand video data, aligning the temporal sequence of both data streams. In some examples, audio comparison and/or visual feature correlation are performed to implement the synchronization. A synchronization subsystem can use an audio event captured by audio tracks associated with the video data and the opposite-hand video data, and/or a video event captured by both data streams, to temporally align the two data streams.

At operation 1012, SLAM is performed on the video data using visual features (e.g., 218, 902, and/or 904) captured by the first hand-held device. A SLAM subsystem can process the equirectangular video data to generate SLAM data, including spatial maps and trajectory information. In some examples, the subsystem uses motion data from motion sensors in performing the SLAM operations. In some examples, the video and motion data are combined to perform tightly-coupled vision-IMU fusion.

At operation 1014, SLAM is performed on the opposite-hand video data using visual features captured by the second hand-held device. The SLAM subsystem generates opposite-hand SLAM data, which may include spatial maps and trajectory information for the second device, as in operation 1012.

At operation 1016, joint SLAM is performed using the SLAM data and opposite-hand SLAM data. The video data and/or motion data from the two devices can also be used as additional inputs to the joint SLAM operation. The joint SLAM subsystem performs a SLAM operation to combine the SLAM data from both hands to align the spatial maps and trajectories of both hand-held devices within a unified coordinate system. The joint SLAM subsystem can leverage complementary perspectives and use probabilistic factor graphs to improve accuracy. The joint SLAM processing can use visual features visible within the FOVs of both hand-held devices (such as features 218, 902, and/or 904) to assist in aligning and reconciling the SLAM data from the two devices to generate joint SLAM data. The output of operation 1016 is joint SLAM data, including a unified spatial map and bimanual trajectory data suitable for robotic training. In some examples, joint SLAM may improve the accuracy of individual hand trajectories by leveraging the motion of one hand to constrain the position of the other hand.

It will be appreciated that some examples may employ a simplified version of method 1000 to process data from only a single camera assembly of a single manipulator device, for example for collecting training data for one-handed manipulation tasks. In such examples, each operation 1006, 1008, and 1012 processes data for only the single device, and operations 1004, 1010, 1014, and 1016 can be omitted.

In some examples, a third camera-enabled device present in the environment can be used to provide a further perspective for enriching the joint SLAM analysis. The third device can be fixed (e.g., a camera affixed to a table or other workspace) or movable (e.g., a head-mounted camera worn by the same user wearing the manipulator devices); in some cases, multiple additional camera-enabled devices can contribute their video data to the SLAM process. In such cases, third-source video data is obtained from each such additional device. The third device has a camera assembly positioned to capture a field of view that encompasses, at least at some points in time, visual features of the environment that are also used by the two manipulator device camera assemblies to perform SLAM. SLAM can be performed using the visual features captured by the third-source video data to generate third-source SLAM data, and the joint SLAM operation can be configured to align and combine the SLAM data, the opposite-hand SLAM data, and the third-source SLAM data. In some cases, the third device also generates motion data and/or position data to assist in the SLAM and joint SLAM operations.

The method 1000 supports the generation of synchronized and spatially accurate training data for robotic manipulation tasks. The output may include synchronized pairs of video streams, unified spatial maps, bimanual trajectory data, grip width values or other manipulator device states, and structured metadata files for use in model training. The video processing pipeline can also include other operations such as video cropping, downsampling, filtering, calibration, and manipulator state estimation using visual tracking features. The method 1000 can be implemented using suitable combinations of hardware and software to automate the collection and preprocessing of training data for robotic control systems.

FIG. 11 illustrates an example sorting and preprocessing stage 710 for generating, collecting, sorting, and preprocessing temporal data streams 708 to generate robotic training data 712.

In some examples, each session recorded by a given hand-held device is stored as a temporal data stream 708, which can include video data, motion data, audio data, and/or other data and metadata. The system can be configured to receive a set of multiple temporal data streams 1102, which can be sorted and paired prior to processing using various techniques, including those described below, then preprocessed by operations such as those described above with reference to operation 806 of method 800 and method 1000 of FIG. 10.

A video stitching and projection subsystem 1106 processes sets of video streams from multiple cameras of each individual device, combining multi-camera views from a given device into a unified wide-angle equirectangular video stream 1110. In some examples, the video stitching and projection subsystem 1106 uses calibration metadata from the device to perform camera alignment and supports wide-angle cameras, arrays of non-wide-angle cameras, or other camera assembly configurations as described above.

In some examples, as described above, dynamic objects can be masked from the video data during the video processing pipeline, such as within the video stitching and projection subsystem 1106.

An audio extraction subsystem 1108 processes the multiple temporal data streams 1102 to isolate audio tracks and segment audio data for synchronization.

A pairing subsystem 1114 receives the unified wide-angle equirectangular video stream 1110 and the extracted audio data for each device and identifies and pairs temporal data streams from sets of two hand-held devices. The pairing subsystem 1114 can use spectral audio fingerprinting, metadata analysis, and/or machine-learning-based classification to determine correspondence between pairs of video streams. In some examples, heuristics such as upload time, manipulator device state, and/or video duration can be used to filter or narrow sets of candidate pairs. In some examples, the pairing subsystem 1114 can detect April tags, QR codes, or barcodes to assist in identifying paired devices.

A synchronization subsystem 1116 receives the paired temporal data streams 1122 from the pairing subsystem 1114 and aligns the temporal sequences of the two data streams to create synchronized pairs 1124, the synchronized pairs 1124 from multiple recorded sessions being collected as a plurality of synchronized pairs of temporal data streams 1126. The synchronization subsystem 1116 can use audio cues and/or visual feature correlation for alignment, as described above, and in some cases can be precise enough to achieve sub-millisecond temporal alignment using techniques such as audio comparison.

The synchronization subsystem 1116 outputs the synchronized pairs 1124 to a left SLAM subsystem 1128 and a right SLAM subsystem 1130. The left SLAM subsystem 1128 processes video data from the left-hand device of the pair, and the right SLAM subsystem 1130 processes video data from the right-hand device of the pair. Each SLAM subsystem 1128 and 1130 generates spatial maps and trajectory data, as described above, using the video and motion data from its respective device. In some examples, the SLAM subsystems 1128 and 1130 use tightly-coupled vision-IMU fusion, probabilistic factor graphs, and fisheye camera models to perform SLAM.

The left SLAM subsystem 1128 and right SLAM subsystem 1130 provide their SLAM data outputs to a joint SLAM subsystem 1132. The joint SLAM subsystem 1132 receives the outputs from both SLAM subsystems and aligns spatial maps and trajectories of both hands within a unified coordinate system. The joint SLAM subsystem 1132 can use complementary perspectives and probabilistic factor graphs to improve trajectory accuracy. In some examples, the joint SLAM subsystem 1132 generates a unified spatial map and bimanual trajectory data for use as part of the training data 712. The training data 712 can therefore include synchronized video streams, synchronized audio streams, synchronized device position streams, unified spatial maps, bimanual trajectory data, device state values, and/or structured metadata files. In some examples, the training data 712 is then formatted and stored for use in machine learning model training.

FIG. 12 and FIG. 13 below provide examples of training and deployment pipelines for machine learning models, suitable for application to the method 800 and system 700 described herein.

### Machine-Learning Pipeline

FIG. 12 is a flowchart depicting a machine-learning pipeline 1200, according to some examples. The machine-learning pipeline 1200 may be used to generate a trained model, for example the trained machine-learning program 1302 of FIG. 13, to perform operations associated with searches and query responses.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Training Phases

Generating a trained machine-learning program may include multiple phases that form part of the machine-learning pipeline 1200, including for example the following phases illustrated in FIG. 12:
Data collection and preprocessing 1202: This phase may include acquiring and cleaning data to ensure that it is suitable for use in the machine learning model. This phase may also include removing duplicates, handling missing values, and converting data into a suitable format.
Feature engineering 1204: This phase may include selecting and transforming the training data 1306 to create features that are useful for predicting the target variable. Feature engineering may include (1) receiving features 1308 (e.g., as structured or labeled data in supervised learning) and/or (2) identifying features 1308 (e.g., unstructured or unlabeled data for unsupervised learning) in training data 1306.
Model selection and training 1206: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 1208: This phase may include evaluating the performance of a trained model (e.g., the trained machine-learning program 1302) on a separate testing dataset. This phase can help determine if the model is overfitting or underfitting and determine whether the model is suitable for deployment.
Prediction 1210: This phase involves using a trained model (e.g., trained machine-learning program 1302) to generate predictions on new, unseen data.
Validation, refinement or retraining 1212: This phase may include updating a model based on feedback generated from the prediction phase, such as new data or user feedback.
Deployment 1214: This phase may include integrating the trained model (e.g., the trained machine-learning program 1302) into a more extensive system or application, such as a web service, mobile app, or IoT device. This phase can involve setting up APIs, building a user interface, and ensuring that the model is scalable and can handle large volumes of data.

FIG. 13 illustrates further details of two example phases, namely a training phase 1304 (e.g., part of the model selection and trainings 1206 of FIG. 12) and a prediction phase 1310 (part of prediction 1210 of FIG. 12). Prior to the training phase 1304, feature engineering 1204 is used to identify features 1308. This may include identifying informative, discriminating, and independent features for effectively operating the trained machine-learning program 1302 in pattern recognition, classification, and regression. In some examples, the training data 1306 includes labeled data, known for pre-identified features 1308 and one or more outcomes. Each of the features 1308 may be a variable or attribute, such as an individual measurable property of a process, article, system, or phenomenon represented by a data set (e.g., the training data 1306). Features 1308 may also be of different types, such as numeric features, strings, and graphs, and may include one or more of content 1312, concepts 1314, attributes 1316, historical data 1318, and/or user data 1320, merely for example.

In training phase 1304, the machine-learning pipeline 1200 uses the training data 1306 to find correlations among the features 1308 that affect a predicted outcome or prediction/inference data 1322.

With the training data 1306 and the identified features 1308, the trained machine-learning program 1302 is trained during the training phase 1304 during machine-learning program training 1324. The machine-learning program training 1324 appraises values of the features 1308 as they correlate to the training data 1306. The result of the training is the trained machine-learning program 1302 (e.g., a trained or learned model).

Further, the training phase 1304 may involve machine learning, in which the training data 1306 is structured (e.g., labeled during preprocessing operations). The trained machine-learning program 1302 implements a neural network 1326 capable of performing, for example, classification and clustering operations. In other examples, the training phase 1304 may involve deep learning, in which the training data 1306 is unstructured, and the trained machine-learning program 1302 implements a deep neural network 1326 that can perform both feature extraction and classification/clustering operations.

In some examples, a neural network 1326 may be generated during the training phase 1304, and implemented within the trained machine-learning program 1302. The neural network 1326 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1326 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1326 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1304, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 1310, the trained machine-learning program 1302 uses the features 1308 for analyzing query data 1328 to generate inferences, outcomes, or predictions, as examples of a prediction/inference data 1322. For example, during prediction phase 1310, the trained machine-learning program 1302 generates an output. Query data 1328 is provided as an input to the trained machine-learning program 1302, and the trained machine-learning program 1302 generates the prediction/inference data 1322 as output, responsive to receipt of the query data 1328.

In some examples, the trained machine-learning program 1302 may be a generative AI model. Generative AI is a term that may refer to any type of artificial intelligence that can create new content from training data 1306. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 1322 include predictions, translations, summaries or media content.

### Machine Architecture

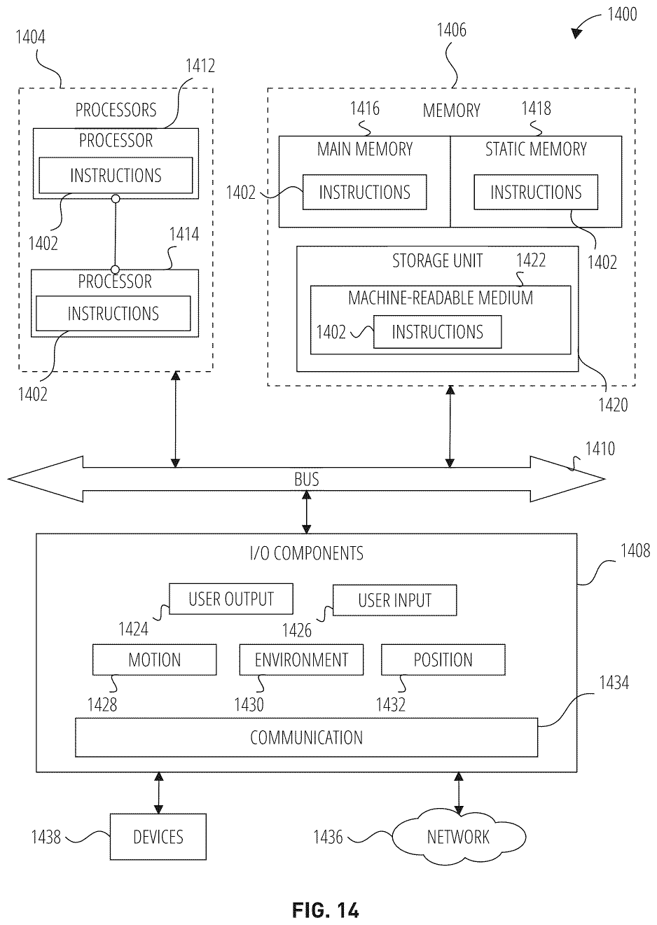

FIG. 14 is a diagrammatic representation of a machine 1400 within which instructions (e.g., software, a program, an application, an applet, an app, or other executable code) for causing the machine 1400 to perform any one or more of the methodologies discussed herein may be executed. For example, the instructions 1402 may implement all or part of the functionality of the system 700 and/or computational subsystems of the sorting and preprocessing stage 710, and cause the machine 1400 to execute any one or more of the methods described herein, such as methods 800 and/or 1000. The instructions 1402 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection of machines that individually or jointly execute the instructions 1402 to perform any one or more of the methodologies discussed herein. In some examples, the machine 1400 may comprise both client and server systems, with certain operations of a particular method or algorithm being performed on the server-side and with certain operations of the particular method or algorithm being performed on the client-side.

The machine 1400 may include processors 1404, memory 1406, and input/output I/O components 1408, which may be configured to communicate with each other via a bus 1410. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1412 and a processor 1414 that execute the instructions 1402. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1416, a static memory 1418, and a storage unit 1420, both accessible to the processors 1404 via the bus 1410. The main memory 1406, the static memory 1418, and storage unit 1420 store the instructions 1402 embodying any one or more of the methodologies or functions described herein. The instructions 1402 may also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 may include a wide variety of components to receive input, provide output, produce output, transmit information, exchange information, capture measurements, and so on. The specific I/O components 1408 that are included in a particular machine will depend on the type of machine. For example, portable machines such as mobile phones may include a touch input device or other such input mechanisms, while a headless server machine will likely not include such a touch input device. It will be appreciated that the I/O components 1408 may include many other components that are not shown in FIG. 14. In various examples, the I/O components 1408 may include user output components 1424 and user input components 1426. The user output components 1424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1408 may include motion components 1428, environmental components 1430, or position components 1432, among a wide array of other components. The motion components 1428 can include acceleration sensor components (e.g., accelerometer), gravitation sensor components, and/or rotation sensor components (e.g., gyroscope).

The environmental components 1430 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 1400 may have a camera system comprising, for example, front cameras on a front surface of the machine 1400 and rear cameras on a rear surface of the machine 1400. The front cameras may, for example, be used to capture still images and video of a user of the machine 1400 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the machine 1400 may also include a 360° camera for capturing 360° photographs and videos.

Further, the camera system of the machine 1400 may include dual rear cameras (e.g., a primary camera as well as a depth-sensing camera), or even triple, quad or penta rear camera configurations on the front and rear sides of the machine 1400. These multiple cameras systems may include a wide camera, an ultra-wide camera, a telephoto camera, a macro camera, and a depth sensor, for example.

The position components 1432 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1408 further include communication components 1434 operable to couple the machine 1400 to a network 1436 or devices 1438 via respective coupling or connections. For example, the communication components 1434 may include a network interface component or another suitable device to interface with the network 1436. In further examples, the communication components 1434 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1438 may be another machine or any of a wide variety of peripheral devices (e.g., a peripheral device coupled via a USB).

Moreover, the communication components 1434 may detect identifiers or include components operable to detect identifiers. For example, the communication components 1434 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1434, such as location via Internet Protocol (IP) geolocation, location via Wi-Fi® signal triangulation, location via detecting an NFC beacon signal that may indicate a particular location, and so forth.

The various memories (e.g., main memory 1416, static memory 1418, and memory of the processors 1404) and storage unit 1420 may store one or more sets of instructions and data structures (e.g., software) embodying or used by any one or more of the methodologies or functions described herein. These instructions (e.g., the instructions 1402), when executed by processors 1404, cause various operations to implement the disclosed examples.

The instructions 1402 may be transmitted or received over the network 1436, using a transmission medium, via a network interface device (e.g., a network interface component included in the communication components 1434) and using any one of several well-known transfer protocols (e.g., hypertext transfer protocol (HTTP)). Similarly, the instructions 1402 may be transmitted or received using a transmission medium via a coupling (e.g., a peer-to-peer coupling) to the devices 1438.

### Software Architecture

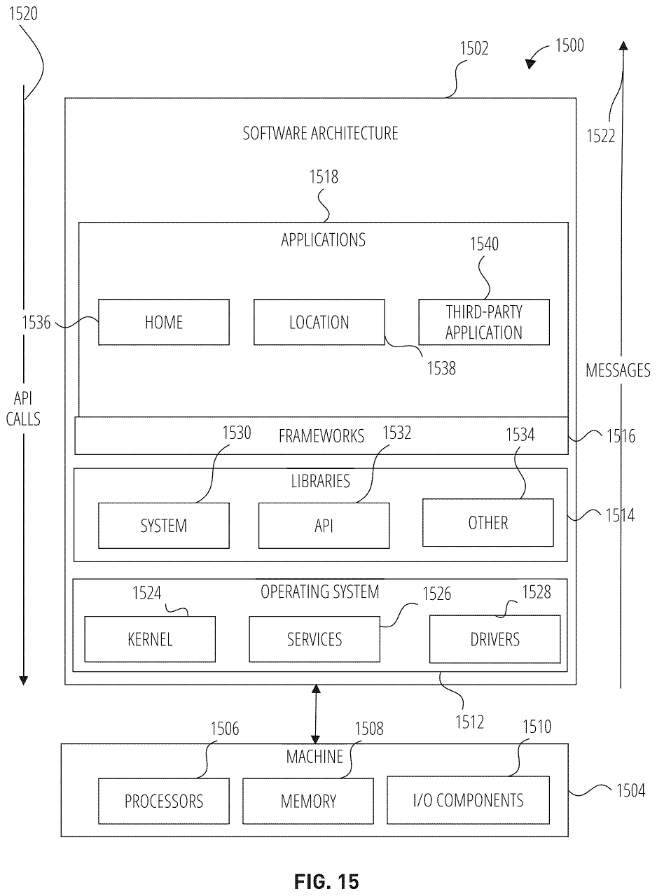

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. Operationally, the applications 1518 invoke API calls 1520 through the software stack and receive messages 1522 in response to the API calls 1520. The system 700 and/or computational subsystems of the sorting and preprocessing stage 710 may be implemented by components in one or more layers of the software architecture 1502.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematic functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which may be specific to a particular operating system or platform.

In an example, the applications 1518 may include a home application 1536, a location application 1538, and a broad assortment of other applications such as a third-party application 1540. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1540 can invoke the API calls 1520 provided by the operating system 1512 to facilitate functionalities described herein.

Described embodiments seek to provide technical solutions to one or more example technical problems, including the following.

First, described example can attempt to address the challenge of collecting large-scale, high-quality robotic training data in environments where traditional teleoperation and forward-facing camera systems encounter limitations. In particular, existing approaches may lose visual tracking when manipulator devices enter occluded spaces (such as the inside of a box, bag, or other container being navigated as part of the manipulation task) or when objects block the camera's frontal view, resulting in incomplete or unreliable datasets. Furthermore, a hand-held device that changes direction frequently during a manipulation task will lose sight of visual landmarks in the environment when changing position unless it is equipped with a wide-angle camera assembly as described herein. The described embodiments utilize hand-wearable manipulator devices equipped with ultra-wide-angle camera assemblies, such as 360-degree or greater-than-hemispheric field-of-view cameras, to capture wide-angle or omnidirectional visual data. This configuration enables the system to maintain robust visual tracking and mapping of both the workspace and the surrounding environment, even in scenarios with significant occlusions or dynamic elements. The camera assemblies are configured to capture a field of view that encompasses the current workspace as well as visual features angularly displaced by at least 90 degrees from the forward-projecting axis defining the workspace. This expanded field of view supports reliable data collection for robotic manipulation training.

Second, described example can attempt to address the technical problem of generating accurate spatial maps and bimanual trajectory data from unsynchronized, multi-device video streams. Examples can employ advanced Simultaneous Localization and Mapping (SLAM) algorithms, including tightly-coupled vision-IMU fusion and joint SLAM optimization, to process video data from multiple hand-wearable devices. Each device's temporal data stream undergoes individual SLAM processing to generate spatial maps and hand trajectory data, followed by joint SLAM operations that align the trajectories of both hands within a unified map. This approach leverages complementary camera perspectives and probabilistic factor graphs to achieve sub-millimeter relative pose accuracy, enabling precise bimanual coordination and high-fidelity spatial representations suitable for training computational models.

Third, described example can attempt to address the issue of dynamic object interference and human presence in video data, which can disrupt SLAM and other vision-based algorithms, using masking techniques. Example systems can incorporate a machine-learned masking component that automatically filters out humans, moving objects, and the gripper itself from the video streams prior to SLAM processing. This masking operation preserves static environmental features and improves the robustness and reliability of spatial tracking, particularly in environments with significant human activity or dynamic elements.

Fourth, described example can attempt to address the technical problem of automating the pairing, synchronization, and processing of video data from multiple unsynchronized devices. Some examples feature a comprehensive data processing pipeline that utilizes audio alignment, machine learning-based left/right hand classification, and metadata analysis to identify and pair corresponding video streams. Audio comparison is performed on overlapping segments to achieve sub-millisecond temporal alignment, and synchronized pairs are generated for downstream processing. The pipeline can further include video stitching and equirectangular projection to enable compatibility with standard computer vision models, as well as automated extraction of gripper state and trajectory data.

The integration of wide-angle vision systems with advanced SLAM algorithms can enable efficient and reliable collection and processing of training data, supporting the development and deployment of computational models for robotic manipulation tasks.

Other technical problems may be addressed by various examples described herein, as will be appreciated by a skilled person.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a device comprising: a hand-held manipulator operable by a user's hand; and a camera assembly comprising at least one camera, the camera assembly configured to capture a field of view encompassing: a workspace wherein the manipulator can approach and interact with objects, the workspace being centered on a forward-projecting axis of the camera assembly; and at least one visual feature of an environment of the device that is angularly displaced by at least 90 degrees from the forward-projecting axis.

In Example 2, the subject matter of Example 1 includes, wherein: the field of view encompasses at least one visible feature of the environment that is angularly displaced by at least 135 degrees from the forward-projecting axis.

In Example 3, the subject matter of Examples 1-2 includes, wherein: the field of view encompasses more than a full 180-degree hemispheric view.

In Example 4, the subject matter of Examples 1-3 includes, wherein: the field of view encompasses a full 360-degree spherical view.

In Example 5, the subject matter of Examples 1-4 includes, wherein: the at least one camera comprises a plurality of cameras; and the field of view of the camera assembly comprises a joint field of view of individual fields of view of the plurality of cameras.

In Example 6, the subject matter of Examples 1-5 includes, wherein: the at least one camera comprises a wide-angle camera having a field of view encompassing more than a full 180-degree hemispheric view.

In Example 7, the subject matter of Examples 1-6 includes, a motion sensor.

Example 8 is a system comprising: at least one processor; and a memory storing instructions that, when executed by the at least one processor, cause the system to perform operations comprising: obtaining video data captured by a camera assembly of a hand-held device, the video data capturing a field of view encompassing: a workspace wherein the handheld device can approach and interact with objects, the workspace being centered on a forward-projecting axis of the camera assembly; and at least one visual feature of an environment of the hand-held device that is angularly displaced by at least 90 degrees from the forward-projecting axis; and performing simultaneous location and mapping (SLAM) using the at least one visual feature captured by the video data to generate SLAM data.

In Example 9, the subject matter of Example 8 includes, wherein: the field of view encompasses at least one visible feature of the environment that is angularly displaced by at least 135 degrees from the forward-projecting axis.

In Example 10, the subject matter of Examples 8-9 includes, wherein: the field of view encompasses more than a full 180-degree hemispheric view.

In Example 11, the subject matter of Examples 8-10 includes, wherein: the field of view encompasses a full 360-degree spherical view.

In Example 12, the subject matter of Examples 8-11 includes, wherein: the at least one camera comprises a plurality of cameras; and the field of view of the camera assembly comprises a joint field of view of individual fields of view of the plurality of cameras.

In Example 13, the subject matter of Example 12 includes, wherein the operations further comprise: stitching the individual fields of view of the plurality of cameras to generate stitched video data prior to performing the SLAM.

In Example 14, the subject matter of Example 13 includes, wherein the operations further comprise: transforming the stitched video data to generate equirectangular video data.

In Example 15, the subject matter of Examples 8-14 includes, wherein: the at least one camera comprises a wide-angle camera having a field of view encompassing more than a full 180-degree hemispheric view.

In Example 16, the subject matter of Examples 8-15 includes, wherein the operations further comprise: obtaining opposite-hand video data captured by a camera assembly of a second hand-held device in the environment, the opposite-hand video data capturing a field of view encompassing the at least one visual feature of the environment; performing SLAM using the at least one visual feature captured by the opposite-hand video data to generate opposite-hand SLAM data; and performing a joint SLAM operation aligning and combining the SLAM data and the opposite-hand SLAM data..

In Example 17, the subject matter of Example 16 includes, wherein: the SLAM and joint SLAM are performed using: motion data generated by a motion sensor of the hand-held device; and opposite-hand motion data generated by a motion sensor of the second hand-held device.

In Example 18, the subject matter of Examples 16-17 includes, wherein the operations further comprise: synchronizing the video data and the opposite-hand video data using one or more of: an audio event captured by audio tracks associated with the video data and the opposite-hand video data; or a video event captured by the video data and the opposite-hand video data.

In Example 19, the subject matter of Examples 8-18 includes, wherein the operations further comprise: masking one or more dynamic objects from the video data prior to performing the SLAM.

Example 20 is a method comprising: obtaining video data captured by a camera assembly of a hand-held device, the video data capturing a field of view encompassing: a workspace wherein the hand-held device can approach and interact with objects, the workspace being centered on a forward-projecting axis of the camera assembly; and at least one visual feature of an environment of the hand-held device that is angularly displaced by at least 90 degrees from the forward-projecting axis; and performing simultaneous location and mapping (SLAM) using the at least one visual feature captured by the video data to generate SLAM data.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the figures, descriptions, and claims herein.

### Additional Examples

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system for generating training data for training a computational model to control a robot, the system comprising: a gripper device mountable to a user's hand, the gripper device comprising: a first finger rotatable inward by inward force applied by a thumb of the hand; a second finger rotatable inward by inward force applied by one or more fingers of the hand; and a camera assembly mounted to the gripper device to capture image data over a field of view comprising at least a portion of the first finger, at least a portion of the second finger, and at least a portion of a workspace extending forward from the first finger and second finger.

In Example 2, the subject matter of Example 1 includes, wherein the gripper device further comprises: a common rotational mechanism constraining the first finger and second finger to rotate jointly such that radial positions of the first finger and second finger relative to the gripper device are both defined by a one-dimensional grip index.

In Example 3, the subject matter of Example 2 includes, wherein: the common rotational mechanism comprises two rotational joints coupled to gears to constrain the fingers to rotate jointly.

In Example 4, the subject matter of Examples 2-3 includes, wherein the gripper device further comprises: visual tracking features integrally formed with the first finger and second finger to present fiducial reference points in the field of view of the camera assembly indicative of the grip index.

In Example 5, the subject matter of Examples 1-4 includes, wherein: the first finger and second finger mirror each other's structure to permit a user to use the gripper device on either hand, the first finger being a right finger when worn on a left hand, the first finger being a left finger when worn on a right hand.

In Example 6, the subject matter of Example 5 includes, wherein: the structure of the first finger and the structure of the second finger are formed by injection molding.

In Example 7, the subject matter of Examples 1-6 includes, wherein: the field of view of the camera assembly further comprises at least a portion of an environment outside of the workspace, comprising line of sight to at least one feature of the environment at more than a 90 degree displacement from an axis extending forward from the gripper device.

In Example 8, the subject matter of Example 7 includes, wherein: the camera assembly comprises a 360 degree camera.

In Example 9, the subject matter of Examples 1-8 includes, wherein: a center of mass of the camera assembly is positioned above the hand.

In Example 10, the subject matter of Examples 1-9 includes, wherein: the first finger and second finger each comprises one or more visually compliant regions visible in the field of view of the camera assembly and configured to visibly deform in response to forces applied to inner surfaces of the fingers.

In Example 11, the subject matter of Example 10 includes, wherein: the one or more visually compliant regions comprise honeycomb structures.

In Example 12, the subject matter of Examples 1-11 includes, wherein the gripper device further comprises: a mask to occlude the one or more fingers and the thumb in the field of view of the camera assembly.

In Example 13, the subject matter of Examples 1-12 includes, wherein the gripper device further comprises: a biasing mechanism to bias the first finger and second finger away from each other; and one or more straps to secure the gripper device to the user's hand.

In Example 14, the subject matter of Example 13 includes, wherein: the one or more straps comprises: a strap to secure the first finger to the thumb; a strap to secure the second finger to at least one of the one or more fingers; and a strap to secure the gripper device to a wrist or palm of the hand.

In Example 15, the subject matter of Examples 1-14 includes, wherein the gripper device further comprises: one or more motion sensors to generate motion data representative of a motion of the gripper device.

In Example 16, the subject matter of Examples 1-15 includes, wherein: the first finger and second finger each comprises: a deformable gripping member defining an inner surface, the gripping member comprising a plurality of zones having different levels of stiffness; the plurality of zones comprises a fingernail structure at a front end of the gripping member having a higher level of stiffness than others of the plurality of zones; the inner surfaces of the gripping members of the two fingers define a multi-antipodal pair of gripping surfaces wherein different pairs of corresponding points on the two inner surfaces are parallel to each other at different radial positions of the two fingers; and at least a portion of the inner surface is textured to improve friction engagement with an object gripped by the gripper device.

In Example 17, the subject matter of Examples 1-16 includes, a robot manipulator mountable to an arm of the robot, the robot manipulator comprising: a pair of robot manipulator fingers rotatably mounted to the robot manipulator to rotate toward each other to grip objects; a robot manipulator camera assembly to capture image data over a robot field of view; an actuator comprising low-backlash metal gears, the actuator constraining rotation of the pair of robot manipulator fingers to joint rotation such that radial positions of the pair of robot manipulator fingers are both defined by a one-dimensional grip index; and visual tracking features integrally formed with the pair of robot manipulator fingers to present fiducial reference points in the field of view of the robot manipulator camera assembly indicative of the grip index; the pair of robot manipulator fingers having a visual profile in the robot field of view, at a plurality of radial positions in rotation toward each other, that matches a visual profile of the first finger and second finger in the field of view of the camera assembly of the gripper device at corresponding radial positions; the robot manipulator being configured for mounting to multiple robot platforms.

Example 18 is a method comprising: mounting a gripper device to a user's hand, the gripper device comprising: a first finger rotatable inward by inward force applied by a thumb of the hand; a second finger rotatable inward by inward force applied by one or more fingers of the hand; and a camera assembly mounted to the gripper device to capture image data over a field of view comprising at least a portion of the first finger, at least a portion of the second finger, and at least a portion of a workspace extending forward from the first finger and second finger; operating the gripper device to capture the image data showing a manipulation task performed by the user; training a computational model using the captured image data; performing inference using the trained computational model to operate a robot having a robot manipulator mounted to an arm of the robot, the robot manipulator comprising: a pair of robot manipulator fingers rotatably mounted to the robot manipulator to rotate toward each other to grip objects; and a robot manipulator camera assembly to capture image data over a robot field of view; the pair of robot manipulator fingers having a visual profile in the robot field of view, at a plurality of radial positions in rotation toward each other, that matches a visual profile of the first finger and second finger in the field of view of the camera assembly of the gripper device at corresponding radial positions.

In Example 19, the subject matter of Example 18 includes, mounting a second gripper device to the user's other hand; and operating the second gripper device during the manipulation task to capture second hand image data; wherein: the training of the computational model uses the captured image data and the captured second hand image data; and the robot has a second robot manipulator mountable to a second arm of the robot.

In Example 20, the subject matter of Examples 17-19 includes, wherein the operations further comprise: obtaining third-source video data captured by a camera assembly of a third device in the environment, the third-source video data capturing a field of view encompassing the at least one visual feature of the environment; and performing SLAM using the at least one visual feature captured by the third-source video data to generate third-source SLAM data; and wherein the joint SLAM operation aligns and combines the SLAM data, the opposite-hand SLAM data, and the third-source SLAM data.

In Example 21, the subject matter of Examples 9-20 includes, wherein the operations further comprise: masking one or more dynamic objects from the video data prior to performing the SLAM.

Example 22 is a method comprising: obtaining video data captured by a camera assembly of a hand-held device, the video data capturing a field of view encompassing: a workspace wherein the hand-held device can approach and interact with objects, the workspace being centered on a forward-projecting axis of the camera assembly; and at least one visual feature of an environment of the hand-held device that is angularly displaced by at least 90 degrees from the forward-projecting axis; and performing simultaneous location and mapping (SLAM) using the at least one visual feature captured by the video data to generate SLAM data.

Example 23 is at least one machine-readable medium including instructions that, when executed by processing circuitry, cause the processing circuitry to perform operations to implement of any of Examples 1-22.

Example 24 is an apparatus comprising means to implement of any of Examples 1-22.

Example 25 is a system to implement of any of Examples 1-22.

Example 26 is a method to implement of any of Examples 1-22.

Other technical features may be readily apparent to one skilled in the art from the figures, descriptions, and claims herein.

### Term Examples

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

What is claimed is:

1. A device comprising:
a hand-held manipulator operable by a user's hand; and
a camera assembly comprising at least one camera, the camera assembly configured to capture a field of view encompassing:
a workspace wherein the manipulator can approach and interact with objects, the workspace being centered on a forward-projecting axis of the camera assembly; and
at least one visual feature of an environment of the device that is angularly displaced by at least 90 degrees from the forward-projecting axis.

2. The device of claim 1, wherein:
the field of view encompasses at least one visible feature of the environment that is angularly displaced by at least 135 degrees from the forward-projecting axis.

3. The device of claim 1, wherein:
the field of view encompasses more than a full 180-degree hemispheric view.

4. The device of claim 1, wherein:
the field of view encompasses a full 360-degree spherical view.

5. The device of claim 1, wherein:
the at least one camera comprises a plurality of cameras; and
the field of view of the camera assembly comprises a joint field of view of individual fields of view of the plurality of cameras.

6. The device of claim 1, wherein:
the at least one camera comprises a wide-angle camera having a field of view encompassing more than a full 180-degree hemispheric view.

7. The device of claim 1, further comprising:
a motion sensor.

8. The device of claim 1, wherein:
the hand-held manipulator comprises a gripper device mountable to a user's hand, the gripper device comprising:
a first finger rotatable inward by inward force applied by a thumb of the hand;
a second finger rotatable inward by inward force applied by one or more fingers of the hand;
a biasing mechanism to bias the first finger and second finger away from each other; and
one or more straps to secure the gripper device to the user's hand; and
the first finger and second finger each comprises one or more visually compliant honeycomb structures visible in the field of view of the camera assembly and configured to visibly deform in response to forces applied to inner surfaces of the fingers.

9. A system comprising:
at least one processor; and
a memory storing instructions that, when executed by the at least one processor, cause the system to perform operations comprising:
obtaining video data captured by a camera assembly of a hand-held device, the video data capturing a field of view encompassing:
a workspace wherein the hand-held device can approach and interact with objects, the workspace being centered on a forward-projecting axis of the camera assembly; and
at least one visual feature of an environment of the hand-held device that is angularly displaced by at least 90 degrees from the forward-projecting axis; and
performing simultaneous location and mapping (SLAM) using the at least one visual feature captured by the video data to generate SLAM data.

10. The system of claim 9, wherein:
the field of view encompasses at least one visible feature of the environment that is angularly displaced by at least 135 degrees from the forward-projecting axis.

11. The system of claim 9, wherein:
the field of view encompasses more than a full 180-degree hemispheric view.

12. The system of claim 9, wherein:
the field of view encompasses a full 360-degree spherical view.

13. The system of claim 9, wherein:
the at least one camera comprises a plurality of cameras; and
the field of view of the camera assembly comprises a joint field of view of individual fields of view of the plurality of cameras.

14. The system of claim 13, wherein the operations further comprise:
stitching the individual fields of view of the plurality of cameras to generate stitched video data prior to performing the SLAM.

15. The system of claim 14, wherein the operations further comprise:
transforming the stitched video data to generate equirectangular video data.

16. The system of claim 9, wherein:
the at least one camera comprises a wide-angle camera having a field of view encompassing more than a full 180-degree hemispheric view.

17. The system of claim 9, wherein the operations further comprise:
obtaining opposite-hand video data captured by a camera assembly of a second handheld device in the environment, the opposite-hand video data capturing a field of view encompassing the at least one visual feature of the environment;
performing SLAM using the at least one visual feature captured by the opposite-hand video data to generate opposite-hand SLAM data; and
performing a joint SLAM operation aligning and combining the SLAM data and the opposite-hand SLAM data.

18. The system of claim 17, wherein:
the SLAM and joint SLAM are performed using:
motion data generated by a motion sensor of the hand-held device; and
opposite-hand motion data generated by a motion sensor of the second hand-held device.

19. The system of claim 17, wherein the operations further comprise:
synchronizing the video data and the opposite-hand video data using one or more of:
an audio event captured by audio tracks associated with the video data and the opposite-hand video data; or
a video event captured by the video data and the opposite-hand video data.

20. The system of claim 17, wherein the operations further comprise:
obtaining third-source video data captured by a camera assembly of a third device in the environment, the third-source video data capturing a field of view encompassing the at least one visual feature of the environment; and
performing SLAM using the at least one visual feature captured by the third-source video data to generate third-source SLAM data; and
wherein the joint SLAM operation aligns and combines the SLAM data, the opposite-hand SLAM data, and the third-source SLAM data.

21. The system of claim 9, wherein the operations further comprise:
masking one or more dynamic objects from the video data prior to performing the SLAM.

22. A method comprising:
obtaining video data captured by a camera assembly of a hand-held device, the video data capturing a field of view encompassing:
a workspace wherein the hand-held device can approach and interact with objects, the workspace being centered on a forward-projecting axis of the camera assembly; and
at least one visual feature of an environment of the hand-held device that is angularly displaced by at least 90 degrees from the forward-projecting axis; and
performing simultaneous location and mapping (SLAM) using the at least one visual feature captured by the video data to generate SLAM data.
